(19) United States
(12) Patent Application Publication
(10) Pub. No.: US 2025/0316265 A1
(43) Pub. Date: Oct. 9, 2025

(54) INFORMATION PROCESSING DEVICE AND INFORMATION PROCESSING METHOD

(71) Applicant: SONY GROUP CORPORATION, TOKYO (JP)

(72) Inventors: TAKUMA MORITA, TOKYO (JP); KATSUTOSHI KANAMORI, TOKYO (JP); NAOYA MURAMATSU, TOKYO (JP); MASAKI TAKAHASHI, TOKYO (JP); TATSUYA WATANABE, TOKYO (JP); YUKI KATSURA, TOKYO (JP)

(21) Appl. No.: 18/849,685

(22) PCT Filed: Mar. 14, 2023
(86) PCT No.: PCT/JP2023/009781

§ 371 Date: Sep. 23, 2024

(30) Foreign Application Priority Data
Mar. 30, 2022 (JP) 2022-056488

(51) Int. Cl. G10L 15/22; G10L 15/08; G10L 15/30

(52) U.S. Cl. CPC G10L 15/22; G10L 15/08; G10L 2015/088; G10L 15/30

(57) ABSTRACT

The present disclosure relates to an information processing device and an information processing method capable of executing appropriate processing on an utterance of a user. An information processing device includes a data processing unit configured to execute at least one of recognition of an episode or recognition of a relationship between a plurality of the episodes, on the basis of a plurality of user utterances issued by a user. The present disclosure can be applied to, for example, a robot that interacts with a user. Furthermore, the present disclosure can be applied to, for example, a server that remotely controls a robot that interacts with a user.

### TECHNICAL FIELD

The present disclosure relates to an information processing device and an information processing method. More specifically, the present disclosure relates to an information processing device and an information processing method for executing processing corresponding to an utterance of a user.

### BACKGROUND ART

In recent years, there is an increase in making use of a voice recognition system that performs voice recognition on a user's utterance and performs processing based on a recognition result.

In such a voice recognition system, it is desired to be able to execute appropriate processing for the user's utterance.

For example, a technology is disclosed in which a user can additionally register or delete a dictionary related to a technical field as necessary, to construct a dictionary configuration according to voice data to be recognized (see, for example, Patent Document 1).

### CITATION LIST

### Patent Document

Patent Document 1: Japanese Patent Application Laid-Open No. 2003-280683

### SUMMARY OF THE INVENTION

### Problems to be Solved by the Invention

The present disclosure has been made in view of such a situation, and an object thereof is to provide an information processing device and an information processing method capable of executing appropriate processing on an utterance of a user.

### Solutions to Problems

A first aspect of the present disclosure is
an information processing device including:
a data processing unit configured to execute at least one of recognition of an episode or recognition of a relationship between a plurality of the episodes, on the basis of a plurality of user utterances issued by a user.

Moreover, a second aspect of the present disclosure is
an information processing method including,
by an information processing device:
executing at least one of recognition of an episode or recognition of a relationship between a plurality of the episodes, on the basis of a plurality of user utterances issued by a user.

Other objects, features, and advantages of the present disclosure will become apparent from a more detailed description based on an embodiment of the present disclosure described below and the accompanying drawings. Note that a system described herein is a logical set configuration of a plurality of devices, and is not limited to a system in which devices with respective configurations are in the same housing.

According to a configuration of an embodiment of the present disclosure, at least one of recognition of an episode or recognition of a relationship between a plurality of the episodes is executed on the basis of a plurality of user utterances issued by a user.

Note that the effects described herein are merely examples and are not limited, and additional effects may also be provided.

### BRIEF DESCRIPTION OF DRAWINGS

FIG. 1 is a diagram for explaining a specific processing example of an interaction robot that responds to a user utterance.

FIG. 2 is a diagram for explaining a specific processing example of the interaction robot that responds to a user utterance.

FIG. 3 is a diagram for explaining a configuration example of an information processing device of the present disclosure.

FIG. 4 is a diagram for explaining a configuration example of the information processing device of the present disclosure.

FIG. 5 is a diagram for explaining processing executed by the information processing device of the present disclosure.

FIG. 6 is a diagram for explaining processing executed by the information processing device of the present disclosure.

FIG. 7 is a diagram for explaining a configuration and processing of a processing determination unit (decision-making unit) of the information processing device of the present disclosure.

FIG. 8 is a flowchart illustrating a sequence of processing executed by the processing determination unit of the information processing device of the present disclosure.

FIG. 9 is a diagram for explaining processing executed by a scenario-based interaction execution module.

FIG. 10 is a diagram for explaining stored data of a scenario database referred to by the scenario-based interaction execution module.

FIG. 11 is a view illustrating a flowchart for explaining processing executed by the scenario-based interaction execution module.

FIG. 12 is a diagram for explaining processing executed by an episode knowledge-based interaction execution module.

FIG. 13 is a diagram for explaining stored data of an episode knowledge database referred to by the episode knowledge-based interaction execution module.

FIG. 14 is a view illustrating a flowchart for explaining processing executed by the episode knowledge-based interaction execution module.

FIG. 15 is a diagram for explaining processing executed by an RDF knowledge-based interaction execution module.

FIG. 16 is a diagram for explaining stored data of an RDF knowledge database referred to by the RDF knowledge-based interaction execution module.

FIG. 17 is a flowchart illustrating processing executed by the RDF knowledge-based interaction execution module.

FIG. 18 is a diagram for explaining processing executed by a situation verbalization & RDF knowledge-based interaction execution module.

FIG. 19 is a view illustrating a flowchart for explaining processing executed by the situation verbalization & RDF knowledge-based interaction execution module.

FIG. 20 is a diagram for explaining processing executed by a machine learning model-based interaction execution module.

FIG. 21 is a view illustrating a flowchart for explaining processing executed by the machine learning model-based interaction execution module.

FIG. 22 is a diagram for explaining processing executed by an execution processing determination unit.

FIG. 23 is a diagram for explaining priority-level information corresponding to an interaction execution module used by the execution processing determination unit.

FIG. 24 is a flowchart illustrating processing executed by the execution processing determination unit.

FIG. 25 is a diagram for explaining an interaction processing sequence executed by the information processing device of the present disclosure.

FIG. 26 is a diagram for explaining an interaction processing sequence executed by the information processing device of the present disclosure.

FIG. 27 is a diagram illustrating a process in which the information processing device of the present disclosure recognizes an episode and a relationship between episodes.

FIG. 28 is a diagram illustrating a process in which the information processing device of the present disclosure recognizes an episode and a relationship between episodes.

FIG. 29 is a diagram illustrating a process in which the information processing device of the present disclosure recognizes an episode and a relationship between episodes.

FIG. 30 is a diagram for explaining a configuration example of an information processing system of the present disclosure.

FIG. 31 is a diagram for explaining a configuration example of a server and a database group of the present disclosure.

FIG. 32 is a view illustrating a flowchart for explaining knowledge data collection processing executed by the server.

FIG. 33 is a view illustrating a flowchart for explaining event analysis processing executed by the server.

FIG. 34 is a view illustrating a flowchart for explaining common topic recognition processing executed by the server.

FIG. 35 is a diagram illustrating an example of a common theme graph.

FIG. 36 is a view illustrating a flowchart for explaining word-of-mouth interaction processing executed by the server.

FIG. 37 is a diagram for explaining a hardware configuration example of the information processing device.

### MODE FOR CARRYING OUT THE INVENTION

Hereinafter, details of the present disclosure will be described with reference to the drawings. Note that the description will be given in the following order.
1. Overview of interaction processing based on voice recognition of user utterance executed by information processing device of present disclosure
2. Configuration example of information processing device of present disclosure
3. Specific configuration example and specific processing example of processing determination unit (decision-making unit)
4. Details of processing in interaction execution module (interaction engine)
4-1. System utterance generation processing by scenario-based interaction execution module
4-2. System utterance generation processing by episode knowledge-based interaction execution module
4-3. System utterance generation processing by RDF knowledge-based interaction execution module
4-4. System utterance generation processing by situation verbalization & RDF knowledge-based interaction execution module
4-5. System utterance generation processing by machine learning model-based interaction execution module
5. Details of processing executed by execution processing determination unit
6. System utterance output example by information processing device of present disclosure
7. Modification of system utterance output by information processing device of present disclosure
8. Configuration example of information processing system of present disclosure
9. Hardware configuration example of information processing device
10. Summary of configuration of present disclosure

### [1. Overview of Interaction Processing Based on Voice Recognition of User Utterance Executed by Information Processing Device of Present Disclosure]

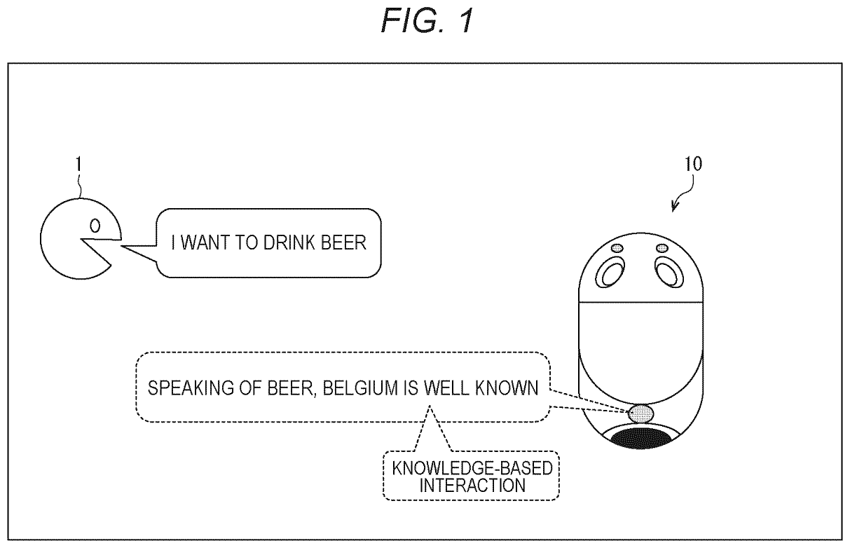

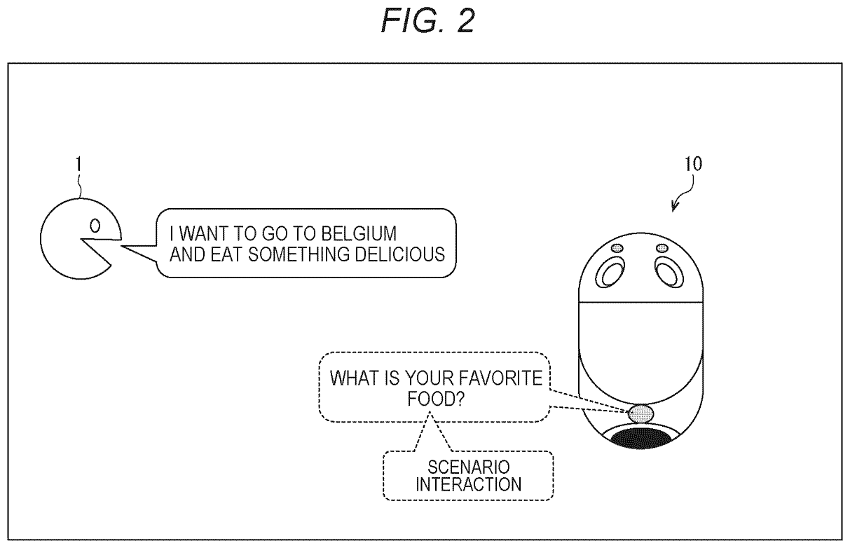

First, with reference to FIGS. 1 and 2, an overview of interaction processing based on voice recognition of a user utterance executed by an information processing device of the present disclosure will be described.

FIG. 1 is a diagram illustrating a processing example of an interaction robot 10, which is an example of the information processing device of the present disclosure, that recognizes a user utterance issued by a user 1 and makes a response.

The interaction robot 10 executes voice recognition processing on a user utterance, for example, User utterance=“I want to drink beer”.

Note that data processing such as the voice recognition processing may be executed by the interaction robot 10 itself or by an external device capable of communicating with the interaction robot 10.

The interaction robot 10 executes response processing based on a voice recognition result of the user utterance. In the example illustrated in FIG. 1, the interaction robot 10 acquires data for responding to User utterance=“I want to drink beer”, generates a response on the basis of the acquired data, and outputs the generated response from a speaker.

In the example illustrated in FIG. 1, the interaction robot 10 makes System response=“Speaking of beer, Belgium is well known”.

Note that, in the present specification, an utterance from a device such as an interaction robot will be written as a “system utterance” or a “system response” to be described.

The interaction robot 10 generates and outputs a response by using knowledge data acquired from a storage unit in the device or knowledge data acquired via a network. That is, the interaction robot 10 refers to a knowledge database, and generates and outputs a system response optimal for the user utterance.

In the example illustrated in FIG. 1, Belgium is registered in the knowledge database as regional information regarding delicious beer, and the interaction robot 10 generates and outputs an optimal system response to the user utterance with reference to registered information in the knowledge database.

FIG. 2 illustrates an example in which the interaction robot 10 makes System response=“What is your favorite food?” as a response to User utterance=“I want to go to Belgium and eat something delicious”.

Unlike the system response of FIG. 1 described above, this system response is not obtained by generating and outputting a system response optimal for the user utterance with reference to the knowledge database. The system response illustrated in FIG. 2 is response processing using a system response registered in a scenario database.

In the scenario database, optimal system utterances corresponding to various user utterances are associated and registered. The interaction robot 10 searches for registration data matching or similar to the user utterance from the scenario database, acquires system response data recorded in the searched registration data, and outputs the acquired system response. As a result, the interaction robot 10 can make the system response as illustrated in FIG. 2.

In the interaction processing of FIGS. 1 and 2, the interaction robot 10 generates and outputs a system response by performing processing according to different algorithms.

For example, in a case where the interaction robot 10 generates a system utterance with reference to the knowledge database for User utterance=“I want to go to Belgium and eat something delicious” illustrated in FIG. 2, similarly to the processing illustrated in FIG. 1, it is expected that, for example, System utterance=“Belgium is famous for delicious chocolate” is generated.

As described above, when the generation algorithms of the system responses executed on the interaction robot 10 side are different, there is a high possibility that contents of responses to the same user utterance will be completely different.

Furthermore, when the interaction robot 10 performs interaction processing using only one response generation algorithm, an optimal system response cannot be generated, and there is a case where a system utterance that is completely wide of the mark for the user utterance is issued. Alternatively, the interaction robot 10 may not be able to make a system response in some cases.

The present disclosure solves such a problem, and achieves an optimal interaction according to various situations by selectively using a plurality of different interaction execution modules (interaction engines). That is, the present disclosure enables optimal system utterance to be issued by changing a response generation algorithm to be applied in accordance with a situation, such as the response generation processing using the knowledge database as illustrated in FIG. 1 or the response generation processing using the scenario database as illustrated in FIG. 2.

### [2. Configuration Example of Information Processing Device of Present Disclosure]

Next, a configuration example of the information processing device of the present disclosure will be described.

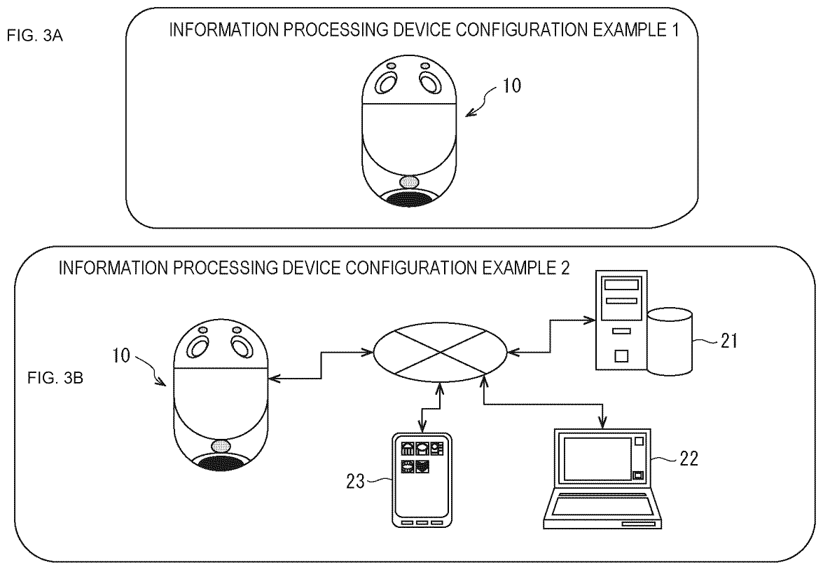

FIG. 3 is a diagram illustrating a configuration example of the information processing device of the present disclosure. FIG. 3 illustrates the following two configuration examples of the information processing device.
(1) Information processing device configuration example 1
(2) Information processing device configuration example 2

In the information processing device configuration example 1 in (1), the information processing device is configured by the interaction robot 10 alone. That is, a configuration is adopted in which the interaction robot 10 executes all the processing such as the voice recognition processing of a user utterance input via a microphone and system utterance generation processing.

In the information processing device configuration example 2 in (2), the interaction robot 10 and an external device connected to the interaction robot 10 constitute the information processing device. The external device is, for example, a server 21, a PC 22, a smartphone 23, or the like.

In this configuration, a user utterance input from the microphone of the interaction robot 10 is transferred to the external device, and the external device performs voice recognition on the user utterance. The external device further generates a system utterance based on a voice recognition result. The external device transmits the generated system utterance to the interaction robot 10, and the interaction robot 10 outputs the system utterance via a speaker.

Note that, in such a system configuration including the interaction robot 10 and the external device, it is possible to variously set sharing of processing executed on the interaction robot 10 side and processing executed on the external device side.

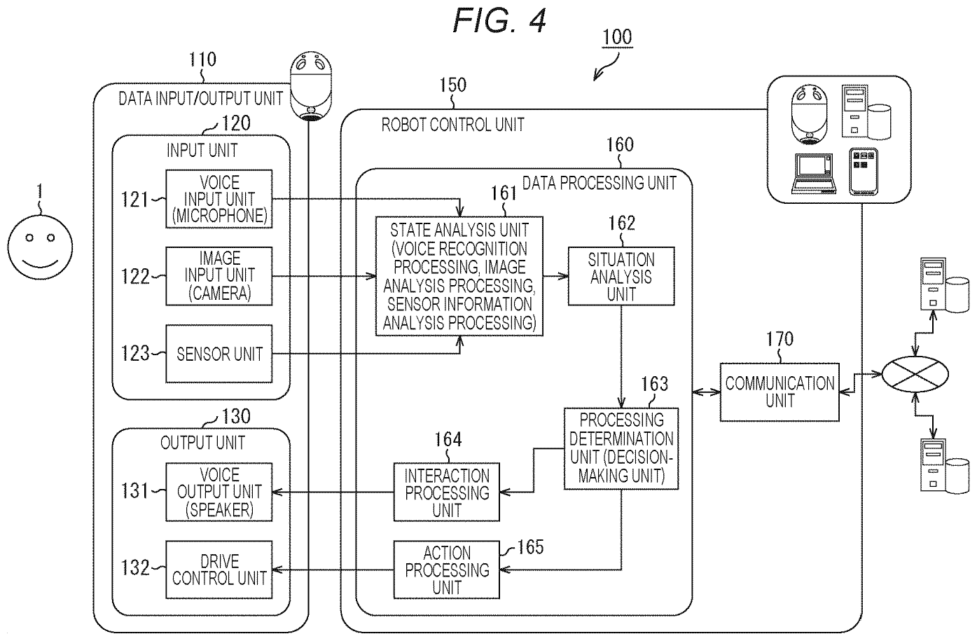

Next, with reference to FIG. 4, a specific configuration example of the information processing device of the present disclosure will be described. FIG. 4 is a diagram illustrating a configuration example of an information processing device 100 of the present disclosure.

The information processing device 100 includes a data input/output unit 110 and a robot control unit 150.

The data input/output unit 110 is a component installed in the interaction robot 10 illustrated in FIG. 1 and the like.

Whereas, the robot control unit 150 is a component that can be installed in the interaction robot 10 illustrated in FIG. 1 and the like, or can be installed in an external device that can communicate with the interaction robot 10. The external device is, for example, the server 21 on a cloud, the PC 22, the smartphone 23, and the like illustrated in FIG. 3. The robot control unit 150 may have a configuration using one or a plurality of these devices.

In a case where the data input/output unit 110 and the robot control unit 150 are configured by different devices, and the data input/output unit 110 and the robot control unit 150 each include a communication unit and execute data input/output with each other via both the communication units.

Note that FIG. 4 illustrates only main elements necessary for explaining processing of the present disclosure. For example, each of the data input/output unit 110 and the robot control unit 150 includes a control unit that controls individual execution processing, a storage unit that stores various data, a user operation unit, a communication unit, and the like, but configurations thereof are not illustrated.

Hereinafter, main components of the data input/output unit 110 and the robot control unit 150 will be described.

The data input/output unit 110 includes an input unit 120 and an output unit 130. The input unit 120 includes a voice input unit 121, an image input unit 122, and a sensor unit 123. The output unit 130 includes a voice output unit 131 and a drive control unit 132.

The voice input unit 121 of the input unit 120 includes, for example, a microphone, and receives voice such as a user utterance as an input.

The image input unit 122 includes, for example, a camera, and captures an image such as a face image of the user.

The sensor unit 123 includes various sensors such as, for example, a distance sensor, a temperature sensor, and an illuminance sensor.

The acquired data of the input unit 120 is input to a state analysis unit 161 in a data processing unit 160 of the robot control unit 150.

Note that, in a case where the data input/output unit 110 and the robot control unit 150 are configured by different devices, the acquired data of the input unit 120 is transmitted from the data input/output unit 110 to the robot control unit 150 via the communication unit.

The voice output unit 131 of the output unit 130 outputs a system utterance generated by an interaction processing unit 164 in the data processing unit 160 of the robot control unit 150.

The drive control unit 132 drives the interaction robot 10. For example, the interaction robot 10 illustrated in FIG. 1 includes a drive unit such as a tire, and can move. For example, the interaction robot 10 can perform movement processing such as approaching the user. Such drive processing such as movement is executed in accordance with a drive command from an action processing unit 165 of the data processing unit 160 of the robot control unit 150.

The robot control unit 150 includes the data processing unit 160 and a communication unit 170.

The communication unit 170 can communicate with an external server. The external server is a server that holds various databases that can be used to generate a system utterance, such as a knowledge database, for example.

The data processing unit 160 includes the state analysis unit 161, a situation analysis unit 162, a processing determination unit 163, the interaction processing unit 164, and the action processing unit 165.

The state analysis unit 161 acquires acquired data input from the input unit 120 (the voice input unit 121, the image input unit 122, and the sensor unit 123) of the data input/output unit 110, and executes state analysis based on the acquired data.

Specifically, the state analysis unit 161 executes analysis on user utterance voice input from the voice input unit 121. Furthermore, the state analysis unit 161 analyzes image data input from the image input unit 122, and executes user identification processing based on a user face image, user state analysis processing, and the like.

Note that the state analysis unit 161 executes the user identification processing based on the user face image with reference to, for example, a user DB in which user face images are registered in advance. The user DB is stored in a storage unit accessible by the data processing unit 160.

The state analysis unit 161 further analyzes a state such as a distance from the user, a current temperature, and brightness on the basis of sensor information input from the sensor unit 123.

The state analysis unit 161 successively analyzes acquired data input from the input unit 120 (the voice input unit 121, the image input unit 122, and the sensor unit 123), and outputs state information obtained by the analysis to the situation analysis unit 152.

That is, the state analysis unit 161 outputs time-series state information such as state information acquired at time t1, state information acquired at time t2, and state information acquired at time t3, to the situation analysis unit 152 as needed. Furthermore, the state analysis unit 161 adds, for example, a time stamp indicating the acquisition time of the state information to the state information, and outputs to the situation analysis unit 152.

The state information analyzed by the state analysis unit 161 includes information indicating each state of the own device, a person, an object, a place, and the like.

The state information of the own device includes, for example, information regarding various states of the own device, that is, the interaction robot 10 including the data input/output unit 110. For example, the state information of the own device includes information indicating that the own device is being charged with electricity, and information about a most recently executed action, a remaining battery amount, a device temperature, falling, walking, a current feeling and the like.

The state information of a person includes, for example, information regarding various states of the person included in a camera-captured image, such as a name of the person, a facial expression of the person, a position and an angle of the person, speaking, non-speaking, and utterance data of the person.

The state information of an object includes, for example, information regarding various states of an object included in a camera-imaged image, such as an identification result of the object, a time when the object has been most recently recognized, and a place (an angle, a distance).

The state information of a place includes information regarding various states of a place, such as brightness, a temperature, and indoor or outdoor.

The state analysis unit 161 successively generates the state information including the various pieces of information on the basis of acquired data input from the voice input unit 121, the image input unit 122, and the sensor unit 123, adds a time stamp indicating time information at the time of information acquisition to the generated state information, and outputs to the situation analysis unit 152.

The situation analysis unit 162 generates situation information on the basis of the state information of each time unit sequentially input from the state analysis unit 161, and outputs the generated situation information to the processing determination unit 163.

Note that the situation analysis unit 162 generates situation information having a data format that can be interpreted by an interaction execution module (for example, an interaction engine) in the processing determination unit 163.

The situation analysis unit 162 executes voice recognition processing on a user utterance input from the voice input unit 121 via the state analysis unit 161, for example. Note that the voice recognition processing on the user utterance in the situation analysis unit 162 includes, for example, conversion processing of voice data to text data, to which automatic speech recognition (ASR) or the like is applied.

The processing determination unit 163 includes a decision-making unit that performs decision-making processing of the interaction robot 10, and executes, for example, processing of selecting one system utterance from system utterances generated by a plurality of interaction execution modules.

In accordance with mutually different algorithms, the plurality of interaction execution modules each generates system utterances on the basis of the situation information generated by the situation analysis unit 162.

Note that the plurality of interaction execution modules may be configured inside the processing determination unit 163 or may be configured inside an external server.

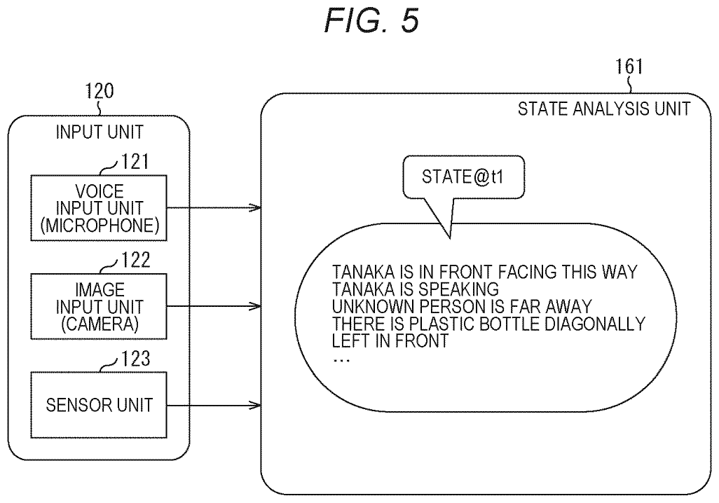

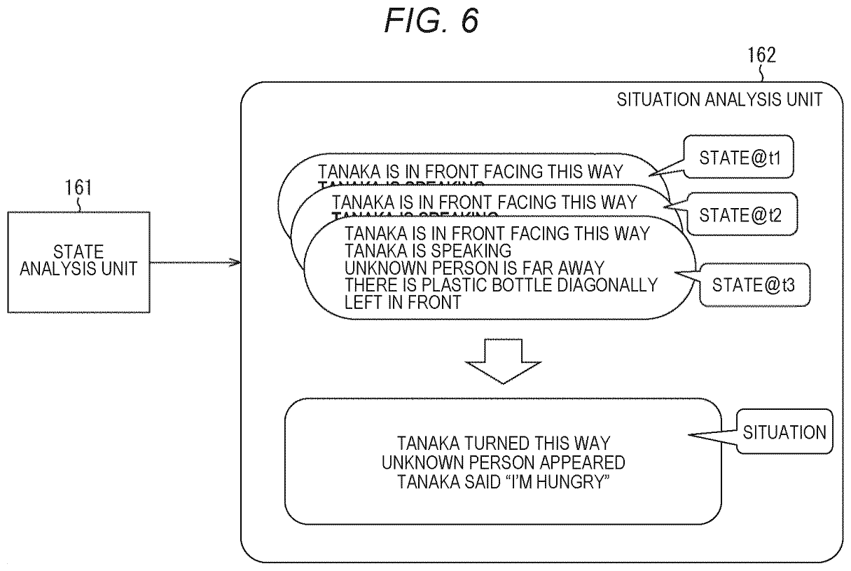

Here, a specific example of processing executed by the state analysis unit 161 and the situation analysis unit 162 will be described with reference to FIGS. 5 and 6.

FIG. 5 illustrates an example of state information at certain time t1 generated by the state analysis unit 161.

That is, the state analysis unit 161 acquires acquired data from the input unit 120 (the voice input unit 121, the image input unit 122, and the sensor unit 123) of the data input/output unit 110 at time t1, and generates the following state information, for example, on the basis of the acquired data.

State information=“Tanaka is in front facing this way. Tanaka is speaking. An unknown person is far away. There is a plastic bottle diagonally left in front . . . .”

The state information generated by the state analysis unit 161 is successively input to the situation analysis unit 162 together with the time stamp.

Next, a specific processing example of the situation analysis unit 162 will be described with reference to FIG. 6. The situation analysis unit 162 generates the situation information on the basis of a plurality of pieces of the state information generated by the state analysis unit 161, that is, column state information of a time system. For example, the following situation information as illustrated in FIG. 6 is generated.

Situation information=“Tanaka turned this way. An unknown person appeared. Tanaka said “I'm hungry””.

As described above, the situation information includes, for example, information indicating a time-series transition or change of a state of the own device, a person, an object, a place, or the like indicated by the state information at each time.

The situation information generated by the situation analysis unit 162 is output to the processing determination unit 163.

The processing determination unit 163 transfers this situation information to the plurality of interaction execution modules.

The plurality of interaction execution modules each executes mutually different system utterance generation algorithms unique to the individual modules on the basis of the situation information generated by the situation analysis unit 162, and individually generates system utterances.

Although the system utterances generated by applying different algorithms individually by the plurality of interaction execution modules are different utterances, the processing determination unit 163 executes processing or the like of selecting one system utterance that should be output, from among the plurality of system utterances.

A specific example of the system utterance generation and selection processing executed by the processing determination unit 163 will be described in detail later.

Moreover, the processing determination unit 163 generates not only the system utterance but also an action of the interaction robot 10, that is, drive control information.

The system utterance selected by the processing determination unit 163 is output to the interaction processing unit 164. Furthermore, the action of the interaction robot 10 generated by the processing determination unit 163 is output to the action processing unit 165.

The interaction processing unit 164 generates utterance text based on the system utterance determined by the processing determination unit 163, and controls the voice output unit 131 of the output unit 130 to output the system utterance. That is, the voice output unit 131 outputs the system utterance by outputting voice based on the utterance text.

Note that, for example, the interaction processing unit 164 may generate voice data based on the system utterance, and the voice output unit 131 may output voice on the basis of the voice data to output the system utterance.

Whereas, the action processing unit 165 generates drive information based on the action of the robot device determined by the processing determination unit 163, and controls the drive control unit 132 of the output unit 130 to drive the interaction robot 10.

### [3. Specific Configuration Example and Specific Processing Example of Processing Determination Unit (Decision-Making Unit)]

Next, a specific configuration example and a specific processing example of the processing determination unit 163 will be described.

As described above, the processing determination unit 163 selects and outputs one system utterance from among a plurality of system utterances generated by the plurality of interaction execution modules each.

In accordance with the mutually different algorithms, the plurality of interaction execution modules each generates system utterances that should be executed next, on the basis of the situation information generated by the situation analysis unit 162, specifically, for example, a user utterance included in the situation information.

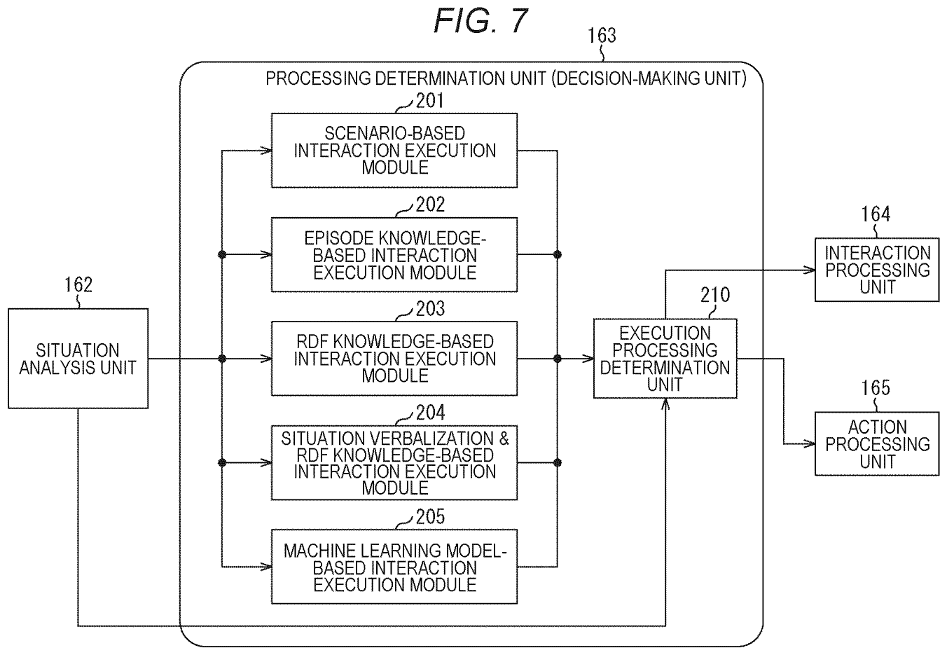

FIG. 7 illustrates a specific configuration example of the processing determination unit 163.

In the example illustrated in FIG. 7, the processing determination unit 163 includes the following five interaction execution modules.
(1) Scenario-based interaction execution module 201
(2) Episode knowledge-based interaction execution module 202
(3) Resource description framework (RDF) knowledge-based interaction execution module 203
(4) Situation verbalization & RDF knowledge-based interaction execution module 204
(5) Machine learning model-based interaction execution module 205

These five interaction execution modules execute processing in parallel, and individually generate system responses with different algorithms.

Note that, FIG. 7 illustrates an example in which the interaction execution modules 201 to 205 are provided in the processing determination unit 163, but the interaction execution modules 201 to 205 may be individually provided in an external device such as an external server, for example.

In this case, the processing determination unit 163 executes communication with the external device such as an external server via the communication unit 170. The processing determination unit 163 transmits the situation information generated by the situation analysis unit 162, specifically, for example, a user utterance or the like included in the situation information to the external device such as an external server via the communication unit 170.

The interaction execution modules 201 to 205 in the external device such as an external server generate system utterances according to algorithms unique to the individual modules on the basis of the received situation information such as the user utterance, and transmit the system utterances to the processing determination unit 163.

The system utterances generated by the interaction execution modules 201 to 205 provided in the processing determination unit 163 or the external device are input to an execution processing determination unit 210 in the processing determination unit 163 illustrated in FIG. 7.

The execution processing determination unit 210 selects one system utterance that should be output from the input system utterance.

The selected system utterance is output to the interaction processing unit 164, converted into text, and output to the voice output unit 131.

Note that the interaction execution modules 201 to 205 perform the system utterance generation processing according to the individual algorithms, but not all the modules always succeed in generating the system utterances. For example, all five modules may fail to generate the system utterances. In such a case, the execution processing determination unit 210 determines an action of the interaction robot 10, and outputs information indicating the determined action to the action processing unit 165.

The action processing unit 165 generates drive information based on the action determined by the processing determination unit 163, and controls the drive control unit 132 of the output unit 130 to drive the interaction robot 10.

Note that the situation information generated by the situation analysis unit 162 is directly input to the processing determination unit 163, and the action of the interaction robot 10 may be determined on the basis of the situation information, for example, the situation information other than the user utterance.

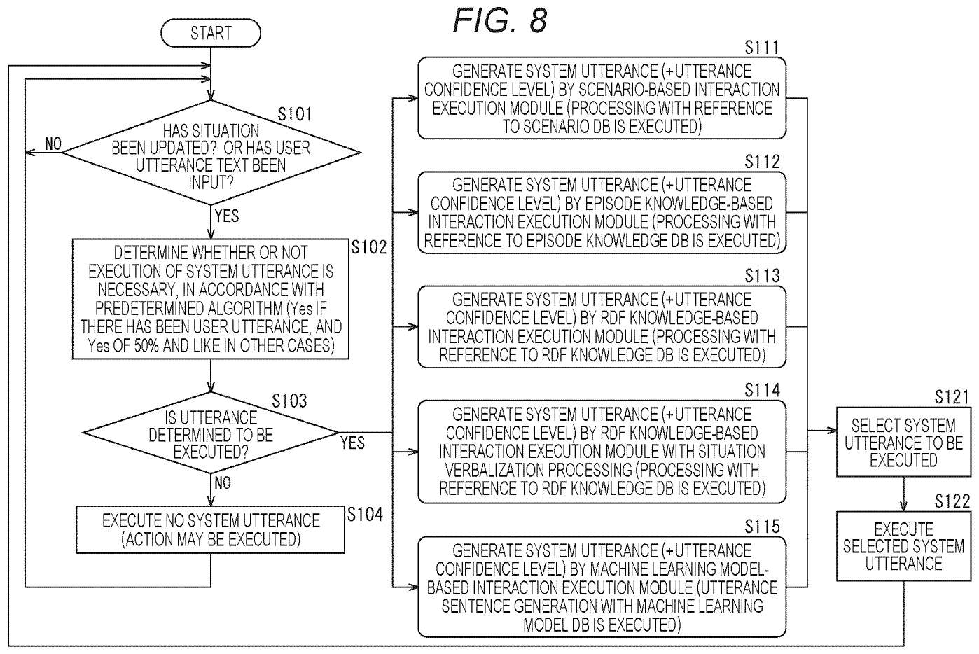

Next, a sequence of processing executed by the processing determination unit 163 will be described with reference to FIG. 8.

FIG. 8 is a flowchart illustrating a sequence of processing executed by the processing determination unit 163.

The processing according to the flowchart can be executed according to a program stored in the storage unit of the robot control unit 150 of the information processing device 100, and can be executed, for example, under control of a control unit (data processing unit 160) including a processor such as a CPU having a program execution function.

Hereinafter, processing of each step of the flowchart illustrated in FIG. 8 will be described.

### (Step S101)

First, in step S101, the processing determination unit 163 determines whether or not a situation has been updated or user utterance text has been input. Specifically, it is determined whether or not new situation information or a user utterance has been input to the processing determination unit 163 from the situation analysis unit 162.

When it is determined that new situation information or a user utterance has not been input to the processing determination unit 163 from the situation analysis unit 162, the processing remains in step S101. Whereas, when it is determined that new situation information or a user utterance has been input to the processing determination unit 163 from the situation analysis unit 162, the processing proceeds to step S102.

### (Step S102)

In step S102, the processing determination unit 163 determines whether or not execution of a system utterance is necessary, in accordance with a predetermined algorithm.

The predetermined algorithm is specifically, for example, an algorithm in which a system utterance is executed in a case where a user utterance has been input, and a system utterance is executed at a frequency of once every two times in a case where a user utterance has not been input, that is, in a case where there is only a situation change.

### (Step S103)

In step S103, the processing determination unit 163 determines whether or not it has been determined to execute a system utterance in the execution necessity determination processing of the system utterance in step S102.

When it is determined that it is determined not to execute a system utterance, the processing proceeds to step S104.

### (Step S104)

In step S104, the processing determination unit 163 does not execute a system utterance.

Note that, in this case, the processing determination unit 163 may output an instruction to the action processing unit 165 to cause the interaction robot 10 to execute an action such as movement processing, for example.

Thereafter, the processing returns to step S101, and the processing in and after step S101 is executed.

### (Steps S111 to S115)

Whereas, when it is determined in step S103 that execution of a system utterance is determined, the processing of the following steps S111 to S115 is executed in parallel.
(S111) System utterance generation processing (+utterance confidence level setting processing) by the scenario-based interaction execution module 201 (processing with reference to a scenario DB is executed)
(S112) System utterance generation processing (+utterance confidence level setting processing) by the episode knowledge-based interaction execution module 202 (processing with reference to an episode knowledge DB is executed)
(S113) System utterance generation processing (+utterance confidence level setting processing) by the RDF knowledge-based interaction execution module 203 (processing with reference to an RDF knowledge DB is executed)
(S114) System utterance generation processing (+utterance confidence level setting processing) by the RDF knowledge-based interaction execution module 204 with situation verbalization processing (processing with reference to the RDF knowledge DB is executed)
(S115) System utterance generation processing (+utterance confidence level setting processing) by the machine learning model-based interaction execution module 205 (processing with reference to a machine learning model is executed)

As described above, the processing by the five interaction execution modules 201 to 205 may be executed in the data processing unit 160 of the robot control unit 150 illustrated in FIG. 4, or may be executed using an external device such as an external server connected via the communication unit 170. For example, a configuration may be adopted in which five external servers individually execute five processes of steps S111 to S115, and the processing determination unit 163 in the data processing unit 160 of the robot control unit 150 illustrated in FIG. 4 may receive processing results.

Details of the five processes executed by the interaction execution modules 201 to 205 will be described later.

The interaction execution modules each generate system utterances corresponding to one and the same situation information, for example, one and the same user utterance. However, since the algorithms are different, the individual modules generate different system utterances. Furthermore, generation of a system utterance may fail in some modules.

In the system utterance generation processing of steps S111 to S115, the interaction execution modules 201 to 205 also set a confidence level (Confidence), which is an index value indicating a degree of reliability of the generated system utterance, and outputs the confidence level to the execution processing determination unit 210.

For example, each interaction execution module sets the confidence level to 1.0 in a case where the generation of the system utterance has succeeded, and sets the confidence level to 0.0 in a case where the generation of the system utterance has failed. However, in a case where the generated system utterance is an utterance repeated many times in the past, or in a case where accuracy of the generated system utterance sentence is low, each interaction execution module may set the confidence level to an intermediate value between 0.0 to 1.0, for example, 0.5 or the like.

### (Step S121)

After the processing of steps S111 to S115, the execution processing determination unit 210 of the processing determination unit 163 acquires a plurality of different system utterances generated on the basis of the mutually different algorithms, from the plurality of interaction execution modules 201 to 205.

Then, in step S121, the execution processing determination unit 210 selects one system utterance from the plurality of system utterances acquired from the plurality of interaction execution modules, as a system utterance to be output. This selection processing is executed in consideration of the confidence level associated with the system utterance generated by each module and a priority level of each module set in advance.

For example, the execution processing determination unit 210 selects one system utterance having the highest confidence level from the plurality of system utterances acquired from the plurality of interaction execution modules, as the system utterance to be output by the interaction robot 10.

Note that, in a case where there is a plurality of system utterances having the highest confidence level, the system utterance to be output by the interaction robot 10 is selected in accordance with a preset priority level for each interaction execution module. Details of this processing will be described later.

Note that each of the interaction execution modules 201 to 205 may output only the system utterance without outputting the confidence level. In this case, for example, the following processing is executed on the execution processing determination unit 210 side.

For example, in a case where a system utterance is input from an interaction execution module, the confidence level of the system utterance is set to 1.0. In a case where a system utterance is not input from the interaction execution module, the confidence level of the system utterance is set to 0.0.

### (Step S122)

Finally, in step S122, the processing determination unit 163 causes the interaction robot 10 to output one system utterance selected in step S121.

Specifically, the system utterance determined by the processing determination unit 163 is output to the interaction processing unit 164. The interaction processing unit 164 generates utterance text based on the input system utterance, and controls the voice output unit 131 of the output unit 130 to output voice (that is, the system utterance) based on the utterance text.

### [4. Details of Processing in Interaction Execution Module (Interaction Engine)]

Next, details of the system utterance generation processing using the different interaction execution modules 201 to 205 executed in steps S111 to S115 of the flowchart illustrated in FIG. 8 will be described.

### (4-1. System Utterance Generation Processing by Scenario-Based Interaction Execution Module)

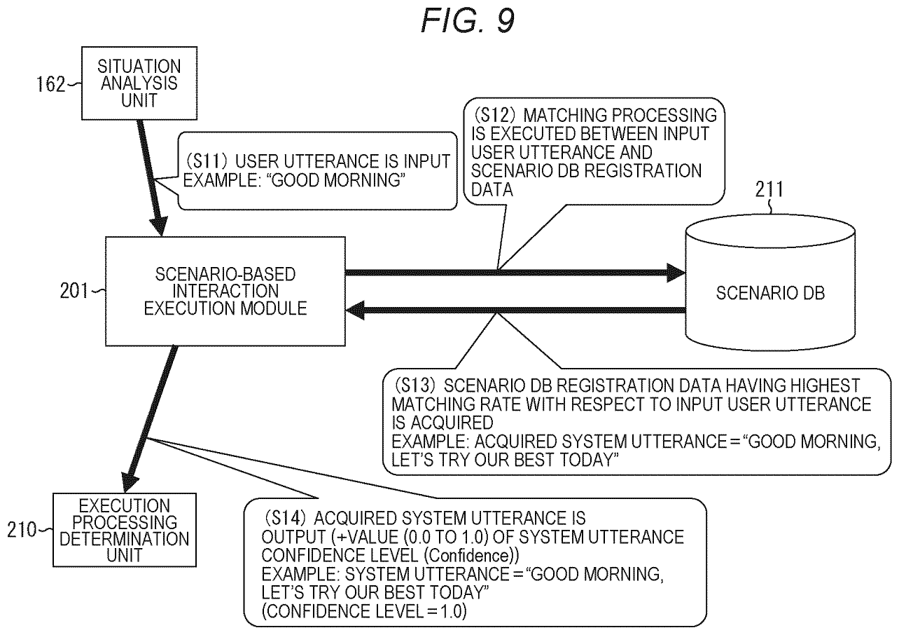

First, details of the system utterance generation processing by the scenario-based interaction execution module 201 executed in step S111 of the flowchart illustrated in FIG. 8 will be described with reference to FIG. 9.

As illustrated in FIG. 9, the scenario-based interaction execution module 201 generates a system utterance with reference to scenario data stored in a scenario database (DB) 211 illustrated in FIG. 9.

The scenario DB 211 is a database provided in the robot control unit 150 or in an external device such as an external server.

The scenario-based interaction execution module 201 executes processing in the order of steps S11 to S14 illustrated in FIG. 9. That is, the scenario-based interaction execution module 201 executes a scenario-based system utterance generation algorithm to generate a scenario-based system utterance.

First, in step S11, a user utterance is input from the situation analysis unit 162 to the scenario-based interaction execution module 201.

For example, the following user utterance is input.
User utterance=“Good morning”

Note that, hereinafter, a user utterance input from the situation analysis unit 162 is referred to as an input user utterance.

In step S12, the scenario-based interaction execution module 201 executes matching processing between the input user utterance and scenario DB registration data.

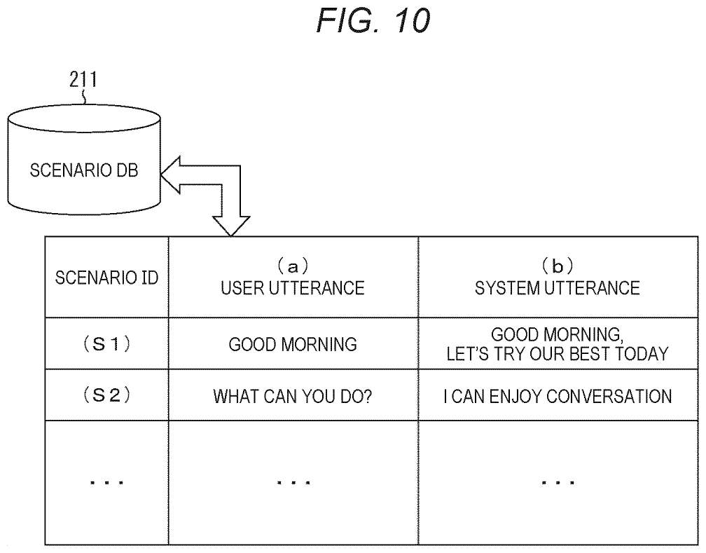

The scenario DB 211 is a database in which utterance set data of user utterances and system utterances according to various interaction scenarios are registered. FIG. 10 illustrates a specific example of registration data of the scenario DB 211.

As illustrated in FIG. 10, in the scenario DB 211, utterance set data of a user utterance and a system utterance is registered for each of various interaction scenarios (Scenario ID=1, 2, . . . ).

In each entry, an optimal system utterance to be executed by the interaction robot 10 (system) according to a certain user utterance is registered. That is, the scenario DB is a database in which optimal system utterances according to user utterances are registered in advance according to various interaction scenarios.

The registration data of the scenario DB 211 includes, for example, question knowledge indicating how to ask a question or the like.

In step S12, the scenario-based interaction execution module 201 executes search processing for determining whether a user utterance matching or similar to the input user utterance has not been registered in the scenario DB, that is, matching processing between the input user utterance and DB registration data.

Next, in step S13, the scenario-based interaction execution module 201 acquires scenario DB registration data having the highest matching rate with respect to the input user utterance.

In the scenario DB 211 illustrated in FIG. 10, as registration data of Scenario ID=(S1), User utterance=Good morning/System utterance=Good morning, let's try our best today are registered.

The scenario-based interaction execution module 201 acquires this database registration data. That is, the scenario-based interaction execution module 201 acquires System utterance=“Good morning, let's try our best today” from the scenario DB 211 for the input User utterance=“Good morning”.

Next, in step S14, the scenario-based interaction execution module 201 outputs the system utterance acquired from the scenario DB 211 to the execution processing determination unit 210.

Note that, in outputting the system utterance, the scenario-based interaction execution module 201 sets the confidence level of the output system utterance, and outputs the confidence level to the execution processing determination unit 210 together with the system utterance. For example, the scenario-based interaction execution module 201 sets the confidence level to 1.0 in a case where generation of the system utterance has succeeded, and sets the confidence level to 0.0 in a case where generation of the system utterance has failed.

Note that, as described above, the scenario-based interaction execution module 201 can output only the system utterance without outputting the confidence level.

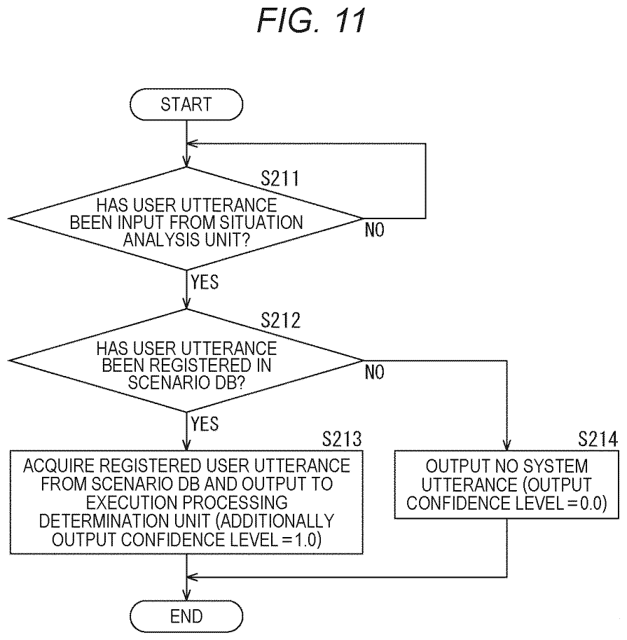

Next, with reference to a flowchart illustrated in FIG. 11, processing of each step of a processing sequence executed by the scenario-based interaction execution module 201 will be sequentially described.

### (Step S211)

First, in step S211, the scenario-based interaction execution module 201 determines whether or not a user utterance has been input from the situation analysis unit 162. When the scenario-based interaction execution module 201 determines that a user utterance has been input, the processing proceeds to step S212.

### (Step S212)

In step S212, the scenario-based interaction execution module 201 determines whether or not a user utterance matching or similar to the input user utterance has been registered in the scenario DB 211.

The scenario-based interaction execution module 201 executes search processing for determining whether a user utterance matching or similar to the input user utterance has been registered in the scenario DB 211, that is, matching processing between the input user utterance and DB registration data.

When it is determined that a user utterance matching or similar to the input user utterance has been registered in the scenario DB 211, the processing proceeds to step S213.

### (Step S213)

In step S213, the scenario-based interaction execution module 201 acquires, from the scenario DB 211, a system utterance corresponding to the registered user utterance in the scenario DB having the highest matching rate with respect to the input user utterance, and outputs the acquired system utterance to the execution processing determination unit 210.

Note that, in a case of outputting a confidence level of the system utterance, since the generation (acquisition) of the system utterance has succeeded, the scenario-based interaction execution module 201 sets the confidence level to 1.0 and outputs the confidence level to the execution processing determination unit 210.

### (Step S214)

Whereas, when it is determined in step S212 that a user utterance matching or similar to the input user utterance has not been registered in the scenario DB 211, the processing proceeds to step S214.

In step S214, the scenario-based interaction execution module 201 does not output the system utterance to the execution processing determination unit 210.

Note that, in a case of outputting a confidence level of the system utterance, since the generation (acquisition) of the system utterance has failed, the scenario-based interaction execution module 201 sets the confidence level to 0.0 and outputs the confidence level to the execution processing determination unit 210.

### (4-2. System Utterance Generation Processing by Episode Knowledge-Based Interaction Execution Module)

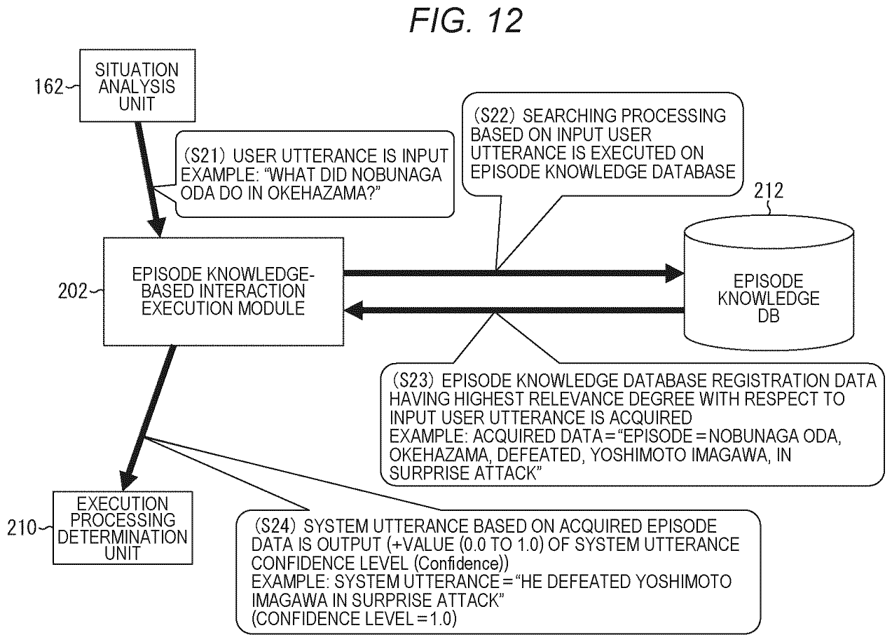

Next, details of the system utterance generation processing by the episode knowledge-based interaction execution module 202 executed in step S112 of the flowchart illustrated in FIG. 8 will be described with reference to FIG. 12.

As illustrated in FIG. 12, the episode knowledge-based interaction execution module 202 generates a system utterance with reference to episode knowledge data stored in an episode knowledge DB 212.

The episode knowledge DB 212 is a database provided in the robot control unit 150 or in an external device such as an external server.

The episode knowledge-based interaction execution module 202 executes processing in the order of steps S21 to S24 illustrated in FIG. 12. That is, the episode knowledge-based interaction execution module 202 executes an episode knowledge-based system utterance generation algorithm to generate an episode knowledge-based system utterance.

First, in step S21, a user utterance is input from the situation analysis unit 162 to the episode knowledge-based interaction execution module 202.

For example, the following user utterance is input.
User utterance=“What did Nobunaga ODA do in Okehazama?”

In step S22, the episode knowledge-based interaction execution module 202 executes searching processing on registration data of the episode knowledge DB 212 on the basis of the input user utterance.

The episode knowledge DB 212 is a database in which various types of episode information such as various episodes, for example, historical facts, news, and user-related surrounding events are recorded. Note that the episode knowledge DB 212 is successively updated. For example, the episode knowledge DB 212 is updated on the basis of information input via the input unit 120 of the data input/output unit 110 of the interaction robot 10.

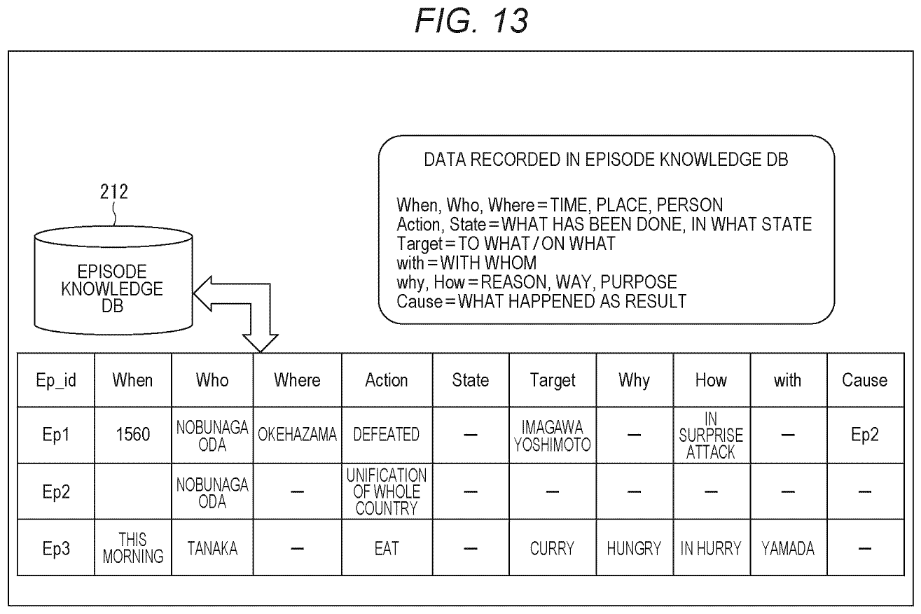

FIG. 13 illustrates a specific example of registration data of the episode knowledge DB 212.

In the episode knowledge DB 212, data indicating episode details is recorded for each of various interaction episodes (Episode ID (Ep_id)=1, 2, . . . ).

Specifically, information including 5W1H as follows is recorded for each episode.
When, Who, Where=time, place, person
Action, State=what has been done, in what state
Target=to what/on what
with=with whom
Why, How=reason, way, purpose
Cause=what happened as a result

Note that, Action, State, and Target corresponds to, for example, What in 5W1H. with corresponds to, for example, Whom.

A database in which these pieces of information are recorded for each episode is the episode knowledge DB 212.

The episode knowledge-based interaction execution module 202 can know detailed information about various episodes by referring to the registered information in the episode knowledge DB 212. The episode knowledge-based interaction execution module 202 executes searching processing on the episode knowledge DB registration data on the basis of the input user utterance.

Processing in a case where the following user utterance is input will be described.
User utterance=“What did Nobunaga ODA do in Okehazama?”

In this case, in step S23, the episode knowledge-based interaction execution module 202 extracts an entry of Episode ID (Ep_id)=Ep1 from episode knowledge DB registration data illustrated in FIG. 13 as an episode including the largest number of words matching words included in the user utterance.

Next, in step S24, the episode knowledge-based interaction execution module 202 generates a system utterance on the basis of episode detailed information included in the entry of the episode ID (Ep_id)=Ep1 acquired from the episode knowledge DB 212, and outputs the system utterance to the execution processing determination unit 210.

For example, the episode knowledge-based interaction execution module 202 generates the following system utterance, and outputs the system utterance to the execution processing determination unit 210.
System utterance=“He defeated Yoshimoto IMAGAWA in a surprise attack”

Note that, in outputting the system utterance, the episode knowledge-based interaction execution module 202 sets the confidence level of the output system utterance, and outputs the confidence level to the execution processing determination unit 210 together with the system utterance. For example, the episode knowledge-based interaction execution module 202 sets the confidence level to 1.0 in a case where generation of the system utterance has succeeded, and sets the confidence level to 0.0 in a case where generation of the system utterance has failed.

Note that, as described above, the episode knowledge-based interaction execution module 202 can output only the system utterance without outputting the confidence level.

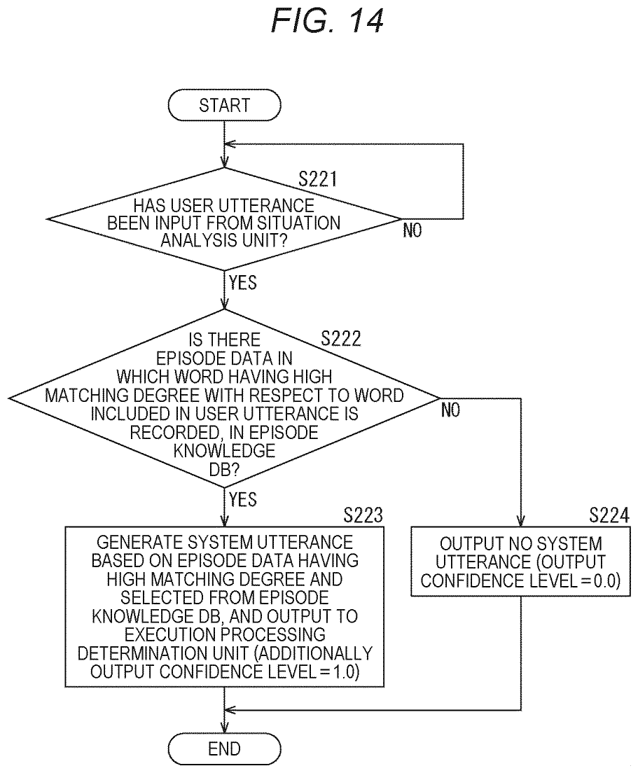

Next, with reference to a flowchart illustrated in FIG. 14, processing of each step of a processing sequence executed by the episode knowledge-based interaction execution module 202 will be sequentially described.

### (Step S221)

First, in step S221, the episode knowledge-based interaction execution module 202 determines whether or not a user utterance has been input from the situation analysis unit 162. When the episode knowledge-based interaction execution module 202 determines that a user utterance has been input, the processing proceeds to step S222.

### (Step S222)

In step S222, the episode knowledge-based interaction execution module 202 determines whether or not episode data including a word matching or similar to a word included in the input user utterance has been registered in the episode knowledge DB 212.

When it is determined that the episode data including a word matching or similar to a word included in the input user utterance has been registered in the episode knowledge DB 212, the processing proceeds to step S223.

### (Step S223)

In step S223, the episode knowledge-based interaction execution module 202 generates a system utterance on the basis of episode detailed information included in an episode acquired from the episode knowledge DB 212, and outputs the system utterance to the execution processing determination unit 210.

Note that, in a case of outputting a confidence level of the system utterance, since the generation (acquisition) of the system utterance has succeeded, the episode knowledge-based interaction execution module 202 sets the confidence level to 1.0 and outputs the confidence level to the execution processing determination unit 210.

### (Step S224)

Whereas, when it is determined in step S222 that the episode data including a word matching or similar to a word included in the input user utterance has not been registered in the episode knowledge DB 212, the processing proceeds to step S224.

In step S224, the episode knowledge-based interaction execution module 202 does not output the system utterance to the execution processing determination unit 210.

Note that, in a case of outputting a confidence level of the system utterance, since the generation (acquisition) of the system utterance has failed, the episode knowledge-based interaction execution module 202 sets the confidence level to 0.0 and outputs the confidence level to the execution processing determination unit 210.

### (4-3. System Utterance Generation Processing by RDF Knowledge-Based Interaction Execution Module)

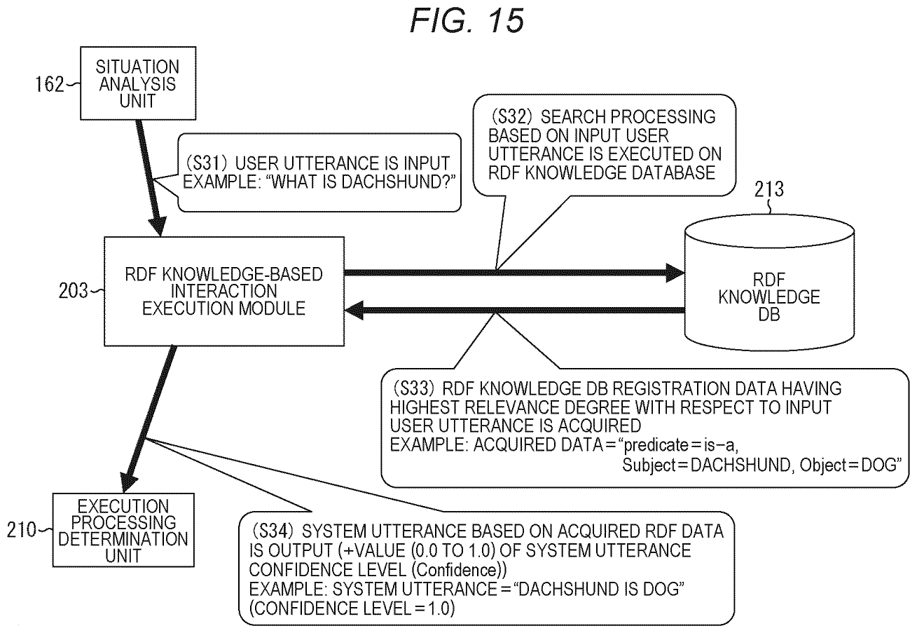

Next, details of the system utterance generation processing by the RDF knowledge-based interaction execution module 203 executed in step S113 of the flowchart illustrated in FIG. 8 will be described with reference to FIG. 15.

As illustrated in FIG. 15, the RDF knowledge-based interaction execution module 203 generates a system utterance with reference to RDF knowledge data stored in an RDF knowledge DB 213.

The RDF knowledge DB 213 is a database provided in the robot control unit 150 or in an external device such as an external server.

The RDF knowledge-based interaction execution module 203 executes processing in the order of steps S31 to S34 illustrated in FIG. 15. That is, the RDF knowledge-based interaction execution module 203 executes an RDF knowledge-based system utterance generation algorithm to generate an RDF knowledge-based system utterance.

Note that the RDF is an abbreviation of resource description framework, is a framework for mainly describing information (resources) on the web, and is a framework standardized in W3C.

The RDF is a framework that describes a relationship between elements, and describes relationship information regarding information (resources) between with three elements of Subject, Predicate, and Object.

For example, information (resources) that “a dachshund is a dog” is classified into three elements of:
Subject=dachshund,
Predicate=is (is-a), and
Object=dog,
and is described as information in which a relationship between the three elements is determined.

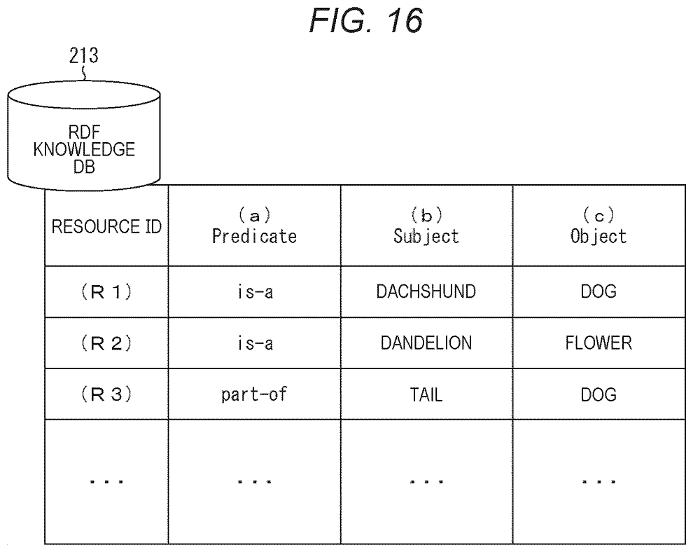

Data recording such a relationship between elements is recorded in the RDF knowledge DB 213. FIG. 16 illustrates an example of data stored in the RDF knowledge DB 213.

As illustrated in FIG. 16, in the RDF knowledge DB 213, various types of information are sectioned into the three elements of:
(a) Predicate,
(b) Subject, and
(c) Object,
and recorded.

Note that the registration data of the RDF knowledge DB 213 includes, for example, Impression knowledge indicating an impression on an event.

By referring to the registered information of the RDF knowledge DB 213, the RDF knowledge-based interaction execution module 203 can know the elements included in various types of information and the relationship between the elements.

In this way, by referring to the elements included in the various types of information and the registration data of the RDF knowledge DB 213 in which the relationship between the elements is recorded, the RDF knowledge-based interaction execution module 203 generates an optimal system utterance according to a user utterance.

First, in step S31, a user utterance is input from the situation analysis unit 162 to the RDF knowledge-based interaction execution module 203.

For example, the following user utterance is input.
User utterance=“What is a dachshund?”

In step S32, the RDF knowledge-based interaction execution module 203 executes search processing on RDF knowledge DB registration data on the basis of the input user utterance.

In step S33, the RDF knowledge-based interaction execution module 203 extracts information (resources) of Resource ID=(R1) from the RDF knowledge DB registration data illustrated in FIG. 16, as information (resources) including the largest number of words matching words included in the user utterance.

In step S34, the RDF knowledge-based interaction execution module 203 generates a system utterance on the basis of information included in an entry of the resource ID (R1) acquired from the RDF knowledge DB 213, that is, elements of: Subject=dachshund,
Predicate=is (is-a), and
Object=dog,
and inter-element information, and outputs the system utterance to the execution processing determination unit 210.

For example, the RDF knowledge-based interaction execution module 203 generates the following system utterance, and outputs the system utterance to the execution processing determination unit 210.

System utterance=“A dachshund is a dog”

Note that, in outputting the system utterance, the RDF knowledge-based interaction execution module 203 sets a confidence level of the output system utterance, and outputs the confidence level to the execution processing determination unit 210 together with the system utterance. For example, the RDF knowledge-based interaction execution module 203 sets the confidence level to 1.0 in a case where generation of the system utterance has succeeded, and sets the confidence level to 0.0 in a case where generation of the system utterance has failed.

Note that, as described above, the RDF knowledge-based interaction execution module 203 can output only the system utterance without outputting the confidence level.

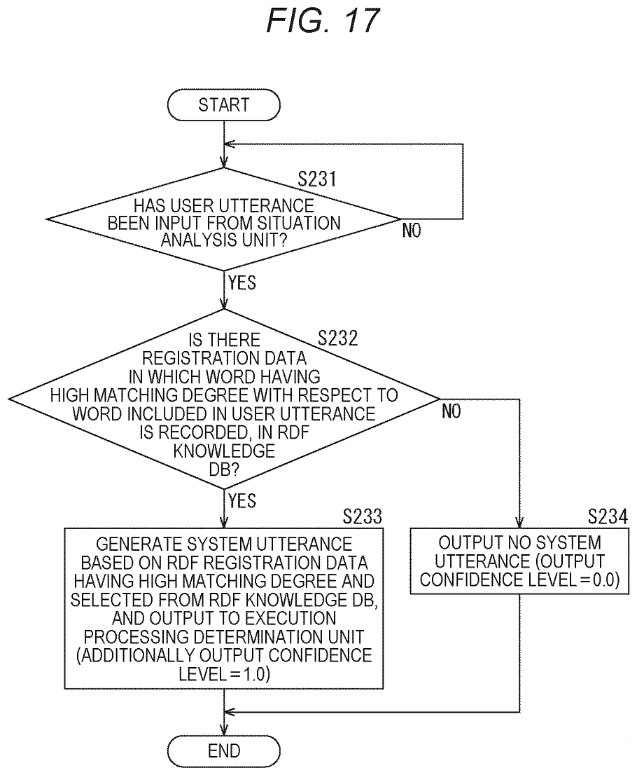

Next, with reference to a flowchart illustrated in FIG. 17, processing of each step of a processing sequence executed by the RDF knowledge-based interaction execution module 203 will be sequentially described.

### (Step S231)

First, in step S231, the RDF knowledge-based interaction execution module 203 determines whether or not a user utterance has been input from the situation analysis unit 162. When the RDF knowledge-based interaction execution module 203 determines that a user utterance has been input, the processing proceeds to step S232.

### (Step S232)

In step S232, the RDF knowledge-based interaction execution module 203 determines whether or not resource data including a word matching or similar to a word included in the input user utterance has been registered in the RDF knowledge DB 213.

When it is determined that information (resources) including a word matching or similar to a word included in the input user utterance is registered in the RDF knowledge DB 213, the processing proceeds to step S233.

### (Step S233)

In step S233, the RDF knowledge-based interaction execution module 203 acquires information (resources) including a word matching or similar to a word included in the input user utterance from the RDF knowledge DB 213, generates a system utterance on the basis of the acquired information, and outputs the system utterance to the execution processing determination unit 210.

Note that, in a case of outputting a confidence level of the acquired system utterance together with the output of the system utterance, the RDF knowledge-based interaction execution module 203 sets the confidence level to 1.0 since the generation (acquisition) of the system utterance has succeeded, and outputs the confidence level to the execution processing determination unit 210.

### (Step S234)

Whereas, when it is determined in step S232 that information (resources) including a word matching or similar to a word included in the input user utterance has not been registered in the RDF knowledge DB 213, the processing proceeds to step S234.

In step S234, the RDF knowledge-based interaction execution module 203 does not output the system utterance to the execution processing determination unit 210.

Note that, in a case of outputting a confidence level of the system utterance, since the generation (acquisition) of the system utterance has failed, the RDF knowledge-based interaction execution module 203 sets the confidence level to 0.0 and outputs the confidence level to the execution processing determination unit 210.

### (4-4. System Utterance Generation Processing by Situation Verbalization & RDF Knowledge-Based Interaction Execution Module)

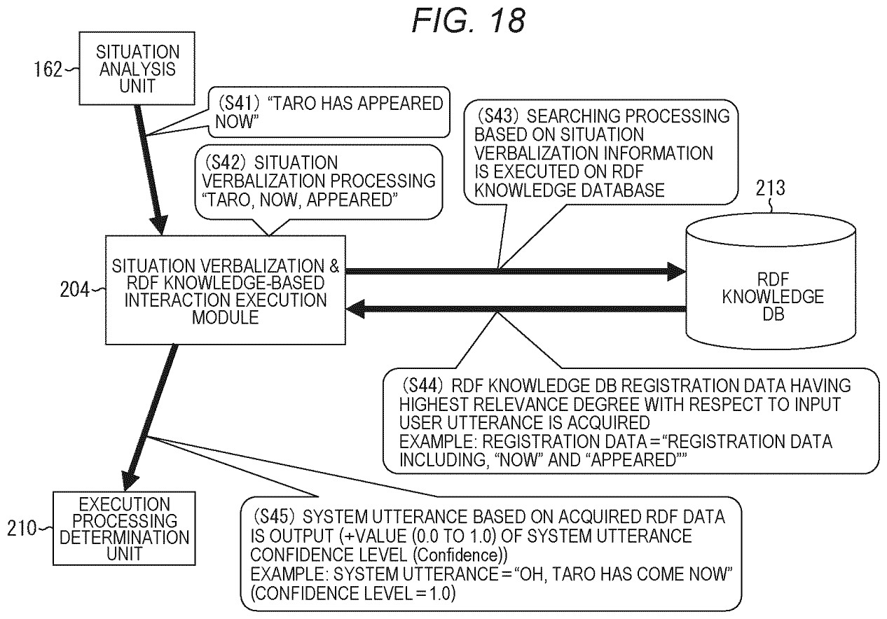

Next, details of the system utterance generation processing by the situation verbalization & RDF knowledge-based interaction execution module 204 executed in step S114 of the flowchart illustrated in FIG. 8 will be described with reference to FIG. 18.

As illustrated in FIG. 18, the situation verbalization & RDF knowledge-based interaction execution module 204 generates a system utterance with reference to RDF knowledge data stored in an RDF knowledge DB 213.

The RDF knowledge DB 213 illustrated in FIG. 18 is a database similar to the RDF knowledge DB 213 described above with reference to FIGS. 15 and 16. That is, the RDF knowledge DB 213 is a database in which various pieces of information (resources) are classified into three elements of a subject, a predicate, and an object, and a relationship between the elements is recorded.

The situation verbalization & RDF knowledge-based interaction execution module 204 executes processing in the order of steps S41 to S45 illustrated in FIG. 18. That is, the situation verbalization & RDF knowledge-based interaction execution module 204 executes a situation verbalization & RDF knowledge-based system utterance generation algorithm to generate a situation verbalization & RDF knowledge-based system utterance.

First, in step S41, situation information is input from the situation analysis unit 162 to the situation verbalization & RDF knowledge-based interaction execution module 204. Here, instead of an input of a user utterance, for example, situation information based on a captured image of the camera is input.

For example, the following situation information is input.
Situation information=“Taro has appeared now”

In step S42, the situation verbalization & RDF knowledge-based interaction execution module 204 executes verbalization processing on the input situation information. This is processing of describing the observed situation as text information similar to the user utterance.

For example, the following situation verbalization information is generated.

Situation verbalization information=Taro, appeared, now

In step S43, the situation verbalization & RDF knowledge-based interaction execution module 204 executes searching processing on registration data of the RDF knowledge DB 213 on the basis of the generated situation verbalization information. In step S44, the situation verbalization & RDF knowledge-based interaction execution module 204 extracts, from the RDF knowledge DB registration data, information (resources) including the largest number of words matching words included in the situation verbalization information.

Next, in step S45, the situation verbalization & RDF knowledge-based interaction execution module 204 generates a system utterance on the basis of information acquired from the RDF knowledge DB 213, and outputs the system utterance to the execution processing determination unit 210.

For example, the situation verbalization & RDF knowledge-based interaction execution module 204 generates the following system utterance, and outputs the system utterance to the execution processing determination unit 210.
System utterance=“Oh, Taro has come now”

Note that, in outputting the system utterance, the situation verbalization & RDF knowledge-based interaction execution module 204 sets the confidence level of the output system utterance, and outputs the confidence level to the execution processing determination unit 210 together with the system utterance. For example, the situation verbalization & RDF knowledge-based interaction execution module 204 sets the confidence level to 1.0 in a case where generation of the system utterance has succeeded, and sets the confidence level to 0.0 in a case where generation of the system utterance has failed.

Note that, as described above, the situation verbalization & RDF knowledge-based interaction execution module 204 can output only the system utterance without outputting the confidence level.

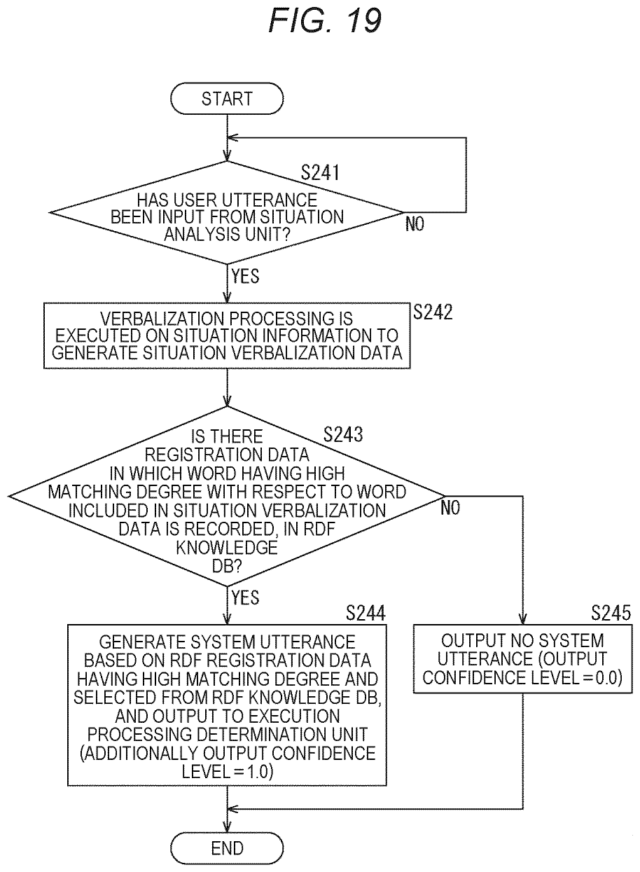

Next, with reference to a flowchart illustrated in FIG. 19, processing of each step of a processing sequence executed by the situation verbalization & RDF knowledge-based interaction execution module 204 will be sequentially described.

### (Step S241)

First, in step S241, the situation verbalization & RDF knowledge-based interaction execution module 204 determines whether or not the situation information has been input from the situation analysis unit 162. When the situation verbalization & RDF knowledge-based interaction execution module 204 determines that the situation information has been input, the processing proceeds to step S242.

### (Step S242)

In step S242, the situation verbalization & RDF knowledge-based interaction execution module 204 executes verbalization processing on the input situation information to generate situation verbalization data.

### (Step S243)

In step S243, the situation verbalization & RDF knowledge-based interaction execution module 204 determines whether or not resource data including a word matching or similar to a word included in the situation verbalization data generated in step S242 has been registered in the RDF knowledge DB 213.

When it is determined that information (resources) including a word matching or similar to a word included in the generated situation verbalization data is registered in the RDF knowledge DB 213, the processing proceeds to step S244.

### (Step S244)

In step S244, the situation verbalization & RDF knowledge-based interaction execution module 204 acquires, from the RDF knowledge DB 213, information (resources) including a word matching or similar to a word included in the generated situation verbalization data, generates a system utterance on the basis of the acquired information, and outputs the system utterance to the execution processing determination unit 210.

Note that, in a case of outputting a confidence level of the acquired system utterance together with the output of the system utterance, the situation verbalization & RDF knowledge-based interaction execution module 204 sets the confidence level to 1.0 since the generation (acquisition) of the system utterance has succeeded, and outputs the confidence level to the execution processing determination unit 210.

### (Step S245)

Whereas, when it is determined in step S243 that information (resources) including a word matching or similar to a word included in the generated situation verbalization data has not been registered in the RDF knowledge DB 213, the processing proceeds to step S245.

In step S245, the situation verbalization & RDF knowledge-based interaction execution module 204 does not output the system utterance to the execution processing determination unit 210.

Note that, in a case of outputting a confidence level of the system utterance, since the generation (acquisition) of the system utterance has failed, the situation verbalization & RDF knowledge-based interaction execution module 204 sets the confidence level to 0.0 and outputs the confidence level to the execution processing determination unit 210.

### (4-5. System Utterance Generation Processing by Machine Learning Model-Based Interaction Execution Module)

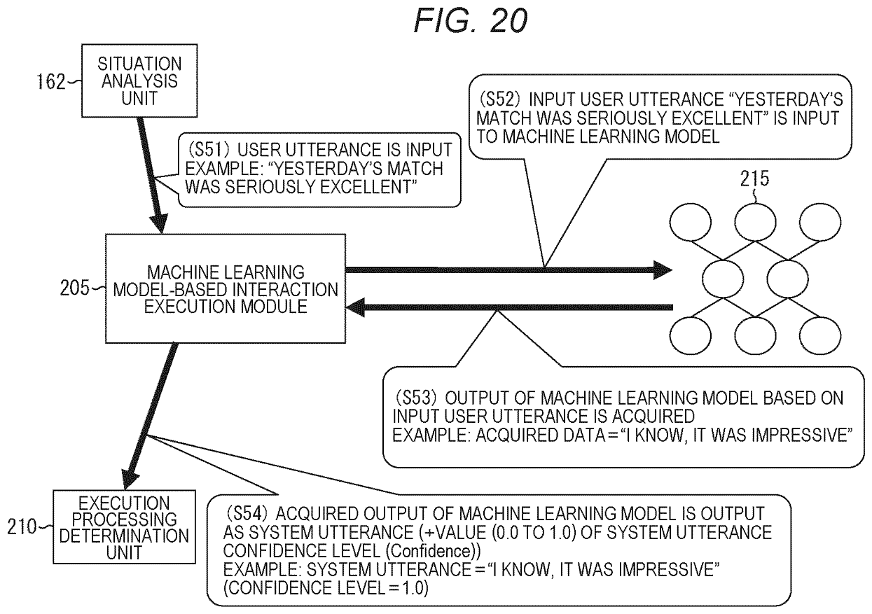

Next, details of the system utterance generation processing by the machine learning model-based interaction execution module 205 executed in step S115 of the flow illustrated in FIG. 8 will be described with reference to FIG. 20.

As illustrated in FIG. 20, the machine learning model-based interaction execution module 205 inputs a user utterance to a machine learning model 215 illustrated in FIG. 20, and acquires a system utterance as an output from the machine learning model 215.

The machine learning model 215 is provided in the robot control unit 150 or in an external device such as an external server.

The machine learning model 215 is a learning model that is input with a user utterance and outputs a system utterance as an output. This machine learning model is a learning model generated by machine learning processing on data of sets of a large number of various different input sentences and response sentences, that is, data including sets of user utterances and an output utterances (system utterances).

This learning model is, for example, a learning model for each user, and update processing is successively performed.

The machine learning model-based interaction execution module 205 executes processing in the order of steps S51 to S52 illustrated in FIG. 20. That is, the machine learning model-based interaction execution module 205 executes a machine learning model-based system utterance generation algorithm using the machine learning model, to generate a machine learning model-based system utterance.

First, in step S51, a user utterance is input from the situation analysis unit 162 to the machine learning model-based interaction execution module 205.

For example, the following user utterance is input.
User utterance=“Yesterday's match was seriously excellent”

In step S52, the machine learning model-based interaction execution module 205 inputs the input user utterance “Yesterday's match was seriously excellent” to the machine learning model 215.

When the machine learning model 215 is input with
User utterance “Yesterday's match was seriously excellent”,
the machine learning model 215 outputs a system utterance as an output for this input.

In step S53, the machine learning model-based interaction execution module 205 acquires an output from the machine learning model 215.

For example, the following data is acquired.
Acquired data=“I know, it was impressive”

In step S54, the machine learning model-based interaction execution module 205 outputs the data acquired from the machine learning model 215 to the execution processing determination unit 210 as a system utterance.

For example, the machine learning model-based interaction execution module 205 outputs the following system utterance to the execution processing determination unit 210.
System utterance=“I know, it was impressive”

Note that, in outputting the system utterance, the machine learning model-based interaction execution module 205 sets a confidence level of the output system utterance, and outputs the confidence level to the execution processing determination unit 210 together with the system utterance. For example, the machine learning model-based interaction execution module 205 sets the confidence level to 1.0 in a case where generation of the system utterance has succeeded, and sets the confidence level to 0.0 in a case where generation of the system utterance has failed.

Note that, as described above, the machine learning model-based interaction execution module 205 can output only the system utterance without outputting the confidence level.

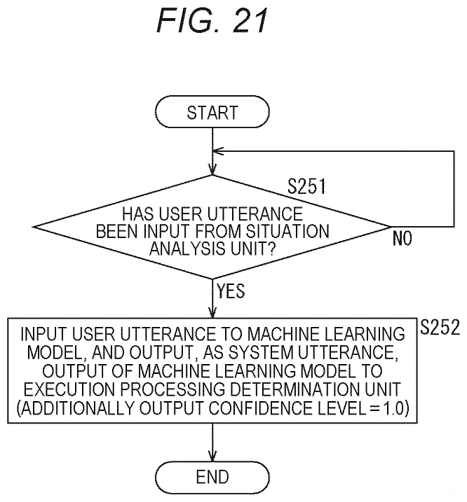

Next, with reference to a flowchart illustrated in FIG. 21, processing of each step of a processing sequence executed by the machine learning model-based interaction execution module 205 will be sequentially described.

### (Step S251)

First, in step S251, the machine learning model-based interaction execution module 205 determines whether or not a user utterance has been input from the situation analysis unit 162. When the machine learning model-based interaction execution module 205 determines that a user utterance has been input, the processing proceeds to step S252.

### (Step S252)

In step S252, the machine learning model-based interaction execution module 205 inputs the user utterance input in step S251 to the machine learning model, acquires an output of the machine learning model, and outputs the output to the execution processing determination unit 210, as a system utterance.

Note that, in a case of outputting a confidence level of the acquired system utterance together with the output of the system utterance, since the generation (acquisition) of the system utterance has succeeded, the machine learning model-based interaction execution module 205 outputs a value of the confidence level of 1.0.

As described above, the five processes of steps S111 to S115 of the flowchart illustrated in FIG. 8 are executed in parallel.

Processing results of steps S111 to S115 of the flow illustrated in FIG. 8, that is, the system utterances generated by the five interaction execution modules 201 to 205 illustrated in FIG. 7 are input to the execution processing determination unit 210 illustrated in FIG. 7.

### [5. Details of Processing Executed by Execution Processing Determination Unit]

Next, details of processing executed by the execution processing determination unit 210 will be described.

As described above with reference to FIG. 7, the execution processing determination unit 210 acquires system utterances generated by the five interaction execution modules 201 to 205, and selects one system utterance that should be output, from among the acquired system utterance. The selected system utterance is output to the interaction processing unit 164, converted into text, and output to the voice output unit 131.

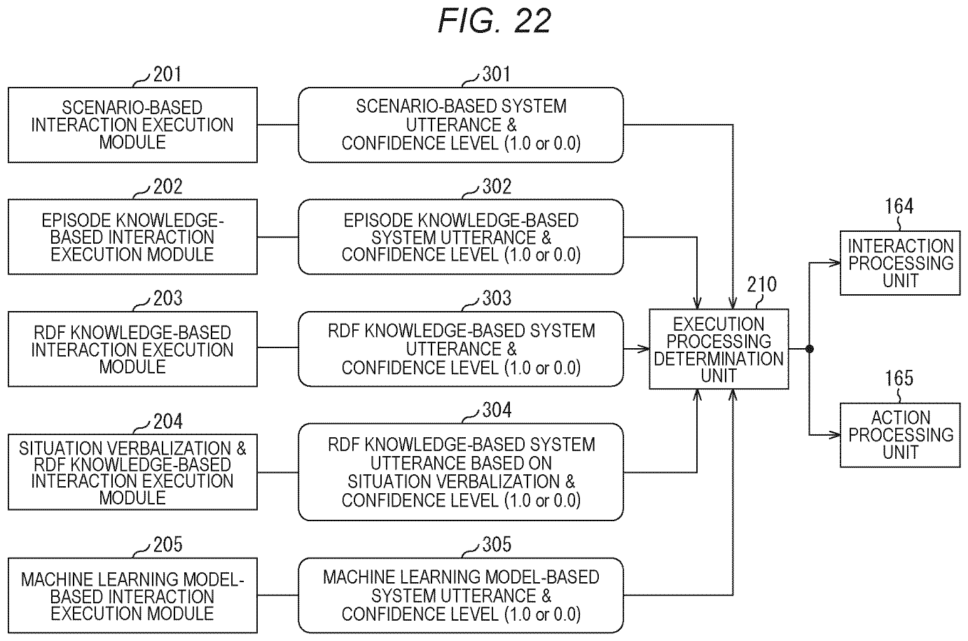

Here, processing executed by the execution processing determination unit 210 will be described with reference to FIG. 22.

As illustrated in FIG. 22, the execution processing determination unit 210 acquires a processing result in each module from the following five interaction execution modules.
(1) Scenario-based interaction execution module 201
(2) Episode knowledge-based interaction execution module 202
(3) RDF knowledge-based interaction execution module 203
(4) Situation verbalization & RDF knowledge-based interaction execution module 204
(5) Machine learning model-based interaction execution module 205

These five interaction execution modules 201 to 205 execute parallel processing, and individually generate system utterances with different algorithms. The five interaction execution modules 201 to 205 input the system utterances generated by the individual modules and a confidence levels (0.0 to 1.0) thereof to the execution processing determination unit 210.

The execution processing determination unit 210 selects one system utterance having the highest value of the confidence level from among the plurality of system utterances input from the five interaction execution modules 201 to 205, and determines the system utterance to be output from the output unit 130 of the data input/output unit 110. That is, the system utterance to be output by the interaction robot 10 is determined.

Note that, in a case where there is a plurality of system utterances having the highest confidence level, the execution processing determination unit 210 determines the system utterance to be output by the interaction robot 10 in accordance with a preset priority level for each interaction execution module.

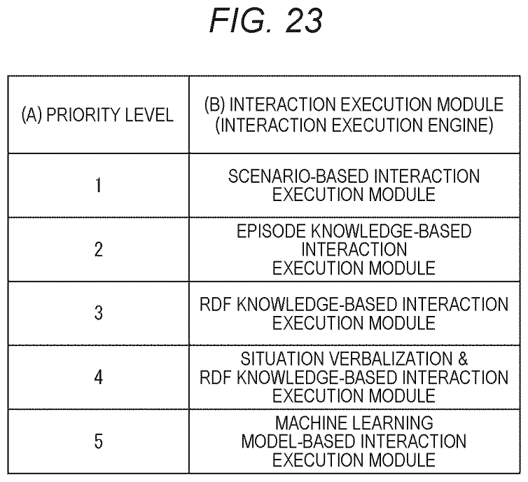

An example of the preset priority level for each interaction execution module will be described with reference to FIG. 23.

As the priority level, 1 is the highest priority level, and 5 is the lowest priority level.

In the example illustrated in FIG. 23, the priority level for each interaction execution module is set as follows.
Priority level 1=Scenario-based interaction execution module 201
Priority level 2=Episode knowledge-based interaction execution module 202
Priority level 3=RDF knowledge-based interaction execution module 203
Priority level 4=Situation verbalization & RDF knowledge-based interaction execution module 204
Priority level 5=Machine learning model-based interaction execution module 205

The execution processing determination unit 210 first selects a system utterance having the highest confidence level as the system utterance to be output by the interaction robot 10, on the basis of the confidence levels input from the plurality of interaction execution modules.

However, in a case where there is a plurality of system utterances having the highest confidence level, the execution processing determination unit 210 selects the system utterance to be output by the interaction robot 10 in accordance with the preset priority level for each interaction execution module illustrated in FIG. 23.

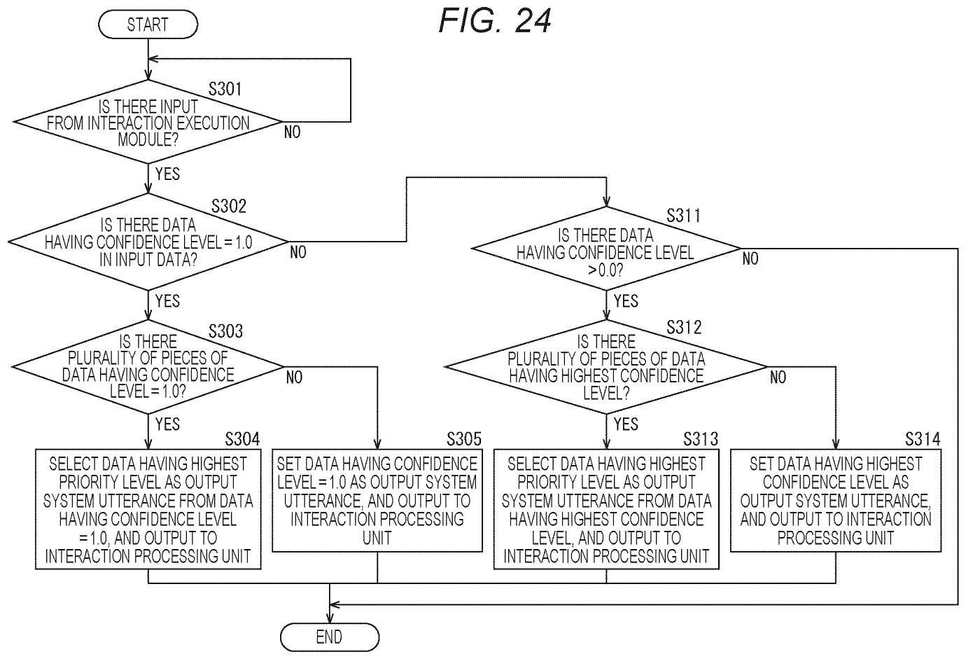

Next, with reference to a flowchart illustrated in FIG. 24, processing of each step of a sequence of processing executed by the execution processing determination unit 210 will be sequentially described.

### (Step S301)

First, in step S301, the execution processing determination unit 210 determines whether or not there has been an input from the five interaction execution modules 201 to 205. That is, the execution processing determination unit 210 determines whether or not there has been a data input of a system utterance generated according to an algorithm executed in each module and a confidence level (0.0 to 1.0) thereof.

When it is determined that there has been an input, the processing proceeds to step S302.

### (Step S302)

In step S302, the execution processing determination unit 210 determines whether or not there is data having a confidence level of 1.0 among the input data from the five interaction execution modules 201 to 205. When it is determined that there is the data, the processing proceeds to step S303.

### (Step S303)

In step S303, the execution processing determination unit 210 determines whether or not there is a plurality of pieces of data having a confidence level of 1.0 among the input data from the five interaction execution modules 201 to 205. When it is determined that there is a plurality of pieces of data, the processing proceeds to step S304.

### (Step S304)

In step S304, the execution processing determination unit 210 selects a system utterance output by a module with a high priority level as a system utterance to be finally output by the interaction robot 10, in accordance with the priority level for each module set in advance, from the plurality of system utterances having the confidence level of 1.0. The execution processing determination unit 210 outputs the selected system utterance to the interaction processing unit 164.

### (Step S305)

Whereas, when it is determined in step S303 that there is not a plurality of pieces of data having the confidence level of 1.0 but only one piece of data, the processing proceeds to step S305.

In step S305, the execution processing determination unit 210 selects one system utterance having the confidence level of 1.0, as the system utterance to be finally output by the interaction robot 10. The execution processing determination unit 210 outputs the selected system utterance to the interaction processing unit 164.

### (Step S311)

Whereas, when it is determined in step S302 that there is no data having the confidence level of 1.0, the processing proceeds to step S311.

In step S311, the execution processing determination unit 210 determines whether or not there is data having a confidence level larger than 0.0 among the input data from the five interaction execution modules 201 to 205. When it is determined that there is the data, the processing proceeds to step S312.

### (Step S312)

In step S312, the execution processing determination unit 210 determines whether or not there is a plurality of pieces of data having the highest confidence level larger than 0.0 among the input data from the five interaction execution modules 201 to 205. When it is determined that there is a plurality of pieces of data, the processing proceeds to step S313.

### (Step S313)

In step S313, the execution processing determination unit 210 selects a system utterance output by a module with a high priority level as a system utterance to be finally output by the interaction robot 10, in accordance with the priority level for each module set in advance, from the plurality of system utterances having the highest confidence level in the data having a confidence level larger than 0.0. The execution processing determination unit 210 outputs the selected system utterance to the interaction processing unit 164.

### (Step S314)

Whereas, when it is determined in step S312 that there is not a plurality of pieces of data having the highest confidence level larger than 0.0 but only one piece of data, the processing proceeds to step S314.

In step S314, the execution processing determination unit 210 selects the system utterance having the highest confidence level of larger than 1.0, as the system utterance to be finally output by the interaction robot 10. The execution processing determination unit 210 outputs the selected system utterance to the interaction processing unit 164.

Whereas, when it is determined in step S311 that there is no data having the confidence level larger than 0.0, the processing ends. In this case, the system utterance is not output.

As described above, the execution processing determination unit 210 selects one system utterance having the highest value of the confidence level from among the plurality of system utterances input from the five interaction execution modules 201 to 205, and sets the selected system utterance as the system utterance to be output by the interaction robot 10.

Whereas, in a case where there is a plurality of system utterances having the highest confidence level, the execution processing determination unit 210 selects the system utterance to be output by the interaction robot 10 in accordance with the preset priority level for each interaction execution module.

As described above, the information processing device of the present disclosure generates a plurality of system utterances by operating, in parallel, the plurality of interaction execution modules that generates system utterances in accordance with different algorithms, and selects and outputs an optimal system utterance from among the plurality of system utterances.

By performing such processing, it is possible to output an optimal system utterance according to various situations, and it is possible to more naturally and smoothly perform an interaction with the user.

### [6. System Utterance Output Example by Information Processing Device of Present Disclosure]

Next, a specific example of a system utterance performed by the processing of the information processing device of the present disclosure described above will be described.

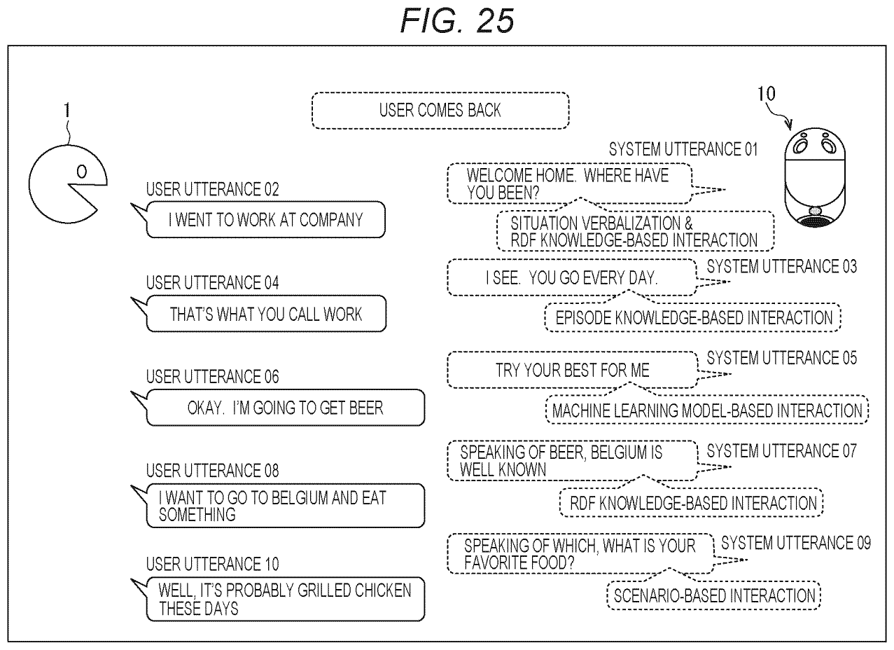

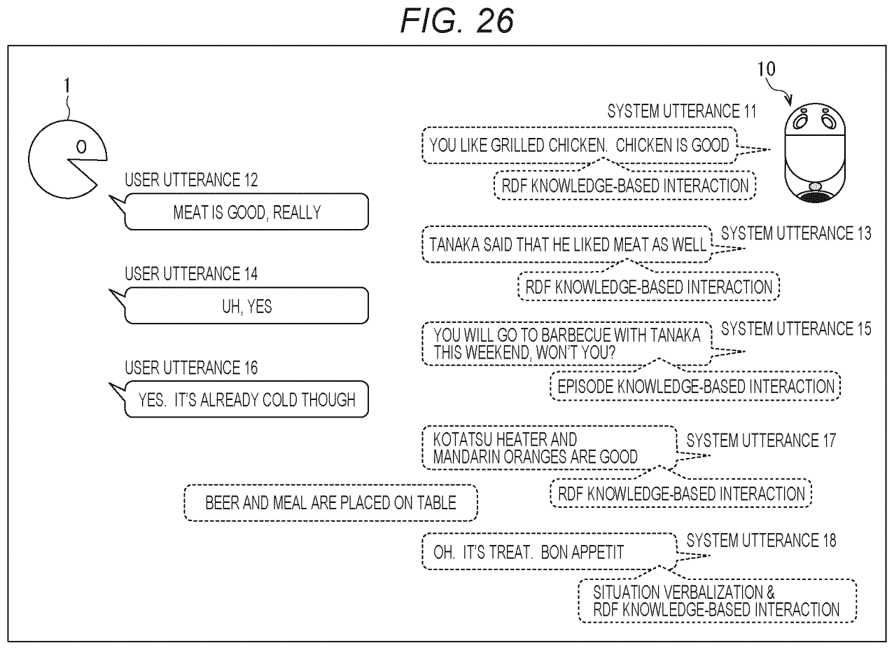

FIGS. 25 and 26 illustrate an example of an interaction sequence between the user 1 and the interaction robot 10.

The interaction robot 10 executes a system utterance by performing the system utterance generation processing according to the processing of the present disclosure described above. In other words, the interaction robot 10 generates a plurality of system utterances by operating, in parallel, the plurality of interaction execution modules 201 to 205 that generates system utterances in accordance with different algorithms, and selects and outputs an optimal system utterance from among the plurality of system utterances.

In the examples of FIGS. 25 to 26, the user 1 and the interaction robot 10 alternately utter System utterance 01, User utterance 02, System utterance 03, . . . , up to User utterance 18. That is, the following interaction sequence is executed.
(The user comes back)
System utterance=“Welcome home. Where have you been?”
User utterance=“I went to work at the company”
System utterance=“I see. You go every day”
User utterance=“That's what you call work”
System utterance=“Do your best for me”
User utterance=“Okay. I'm going to get beer”
System utterance=“Speaking of beer, Belgium is well known”
User utterance=“I want to go to Belgium and eat something”
System utterance=“Speaking of which, what is your favorite food?”
User utterance=“Well, it's probably grilled chicken these days”
System utterance=“You like grilled chicken. Chicken is good”
User utterance=“Meat is good, really”
System utterance=“Tanaka said that he liked meat as well”
User utterance=“Uh, yes”
System utterance=“You will go to a barbecue with Tanaka this weekend, won't you?”
User utterance=“Yes. It's already cold though”
System utterance=“A kotatsu heater and mandarin oranges are good”
(Beer and meal are placed on the table)
System utterance=“Oh. It's a treat. Bon appetit”

In these interaction sequences, each of the system utterances output by the interaction robot 10 is one system utterance selected each time from system utterances generated by the five interaction execution modules 201 to 205.

For example, the first System utterance=“Welcome home. Where have you been?” is a system utterance generated by the situation verbalization & RDF knowledge-based interaction execution module 204 on the basis of the user's situation, that is, situation information indicating that the user has returned.

The next System utterance=“I see. You go every day” is a system utterance generated by the episode knowledge-based interaction execution module 202 on the basis of the immediately preceding user utterance, that is, User utterance=“I went to work at the company”.

The next System utterance=“Try your best for me” is a system utterance generated by the machine learning model-based interaction execution module 205 on the basis of the preceding user utterance, that is, User utterance=“That's what you call work”.

The next System utterance=“Speaking of beer, Belgium is well known” is a system utterance generated by the RDF knowledge-based interaction execution module 203 on the basis of the immediately preceding user utterance, that is, User utterance=“Okay. I'm going to get beer”.

The next System utterance=“Speaking of which, what is your favorite food?” is a system utterance generated by the scenario-based interaction execution module 201 on the basis of the preceding user utterance, that is, User utterance=“I want to go to Belgium and eat something”.

This similarly applies to the following system utterances, and the interaction execution modules 201 to 205 are operated in parallel to generate a plurality of system utterances, and an optimal system utterance is selected from the plurality of system utterances and output.

As described above, the information processing device of the present disclosure generates a plurality of system utterances by operating, in parallel, the plurality of interaction execution modules that generates system utterances in accordance with different algorithms, and selects and outputs an optimal system utterance from among the plurality of system utterances. By performing such processing, it is possible to output an optimal system utterance according to various situations, and it is possible to more naturally and smoothly perform an interaction with the user.

### [7. Modification of System Utterance Output by Information Processing Device of Present Disclosure]

Next, a modification of the system utterance output performed by the processing of the information processing device of the present disclosure described above will be described.

For example, the interaction robot 10 can prompt the user to expand an episode spoken by the user.

For example, the following interaction sequence is executed between the user and the interaction robot 10.
User utterance=“Yesterday, ramen”
System utterance=“Uh-huh”
User utterance=“I ate in Osaka”
System utterance=“Oh, you ate with Mr. A?”
User utterance=“That's right, then”
System utterance=“Uh-huh”
User utterance=“I got burned”
System utterance=“Oh no, are you ok?”
User utterance=“Recovered already”
System utterance=“Oh, good. Why did you get burned?”
User utterance=“The soup was hot”
System utterance=“The soup was hot, so you got burned”

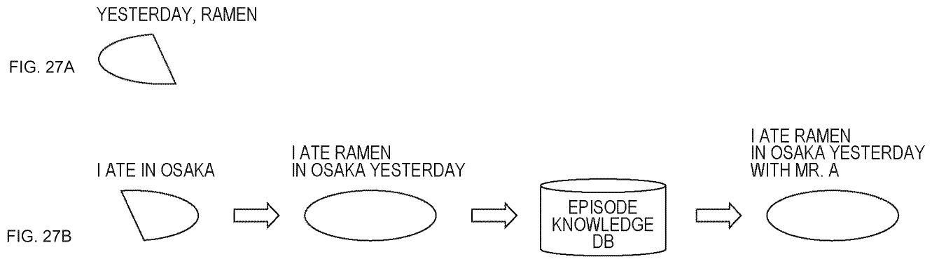

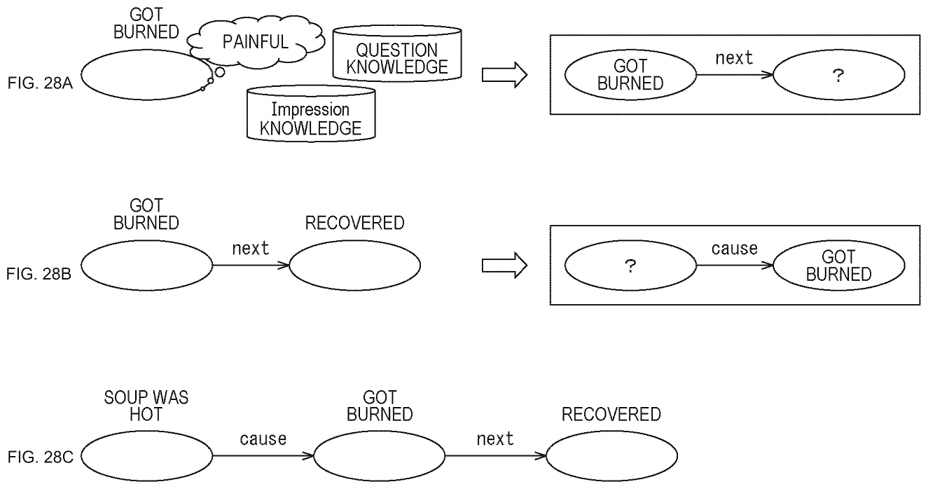

Here, with reference to FIGS. 27 and 28, a process in which the interaction robot 10 outputs the system utterances in the above interaction sequence will be described.

FIGS. 27 and 28 illustrate information (hereinafter, referred to as episode recognition process information) visualized by graphing (diagrammatizing) a process in which the information processing device 100 executes at least one of recognition of an episode spoken by the user or a relationship between a plurality of episodes, on the basis of a plurality of user interactions.

For example, the situation analysis unit 162 of the information processing device 100 can generate and output the episode recognition process information to the outside. For example, a developer of the interaction robot 10 can recognize a process in which the interaction robot 10 recognizes the episode on the basis of the user utterance by referring to the episode recognition process information, and can perform correction and the like of the response generation algorithm on the basis of a recognition result.

For example, in a case where a silent time has continued for a predetermined time or more after the first User utterance=“Yesterday's ramen”, since important information of 5W1H is missing in the user utterance, the situation analysis unit 162 recognizes that the utterance has stopped with the episode being incomplete (“Yesterday's ramen”) as illustrated in A of FIG. 27. The important information in 5W1H is, for example, information such as “what has been done”. Then, after the user says, “Yesterday's ramen”, the situation analysis unit 162 generates situation information indicating that the utterance has stopped with the episode being incomplete, and supplies the situation information to the processing determination unit 163.

In response to this, the interaction robot 10 outputs System utterance=“Uh-huh” that is a back-channel feedback to prompt the user's utterance. This system utterance is, for example, a system utterance generated by the scenario-based interaction execution module 201 with respect to the fact that there is a space between user's utterances.

Next, as illustrated in B of FIG. 27, the situation analysis unit 162 recognizes one episode where the user “ate ramen in Osaka yesterday” in combination with User utterance=“Yesterday, ramen” immediately before, on the basis of the next User utterance=“I ate in Osaka”. The situation analysis unit 162 generates situation information indicating that the user said, “I ate ramen in Osaka yesterday”, and supplies the situation information to the processing determination unit 163.

In response to this, the interaction robot 10 outputs System utterance=“Oh, you ate with Mr. A?”. This system utterance is, for example, as illustrated in B of FIG. 27, a system utterance generated by the episode knowledge-based interaction execution module 202 on the basis of the user utterance “I ate ramen in Osaka yesterday” generated by combining the two user utterances.

Specifically, for example, the episode knowledge-based interaction execution module 202 executes searching processing on registration data of the episode knowledge DB 212 on the basis of the user utterance of “I ate ramen in Osaka yesterday”. As a result, for example, in a case where the episode knowledge-based interaction execution module 202 extracts the episode of the user “I ate ramen with Mr. A”, the episode knowledge-based interaction execution module 202 generates System utterance=“Oh, you ate with Mr. A?” in order to collate the extracted episode with the episode spoken by the user.

Next, in the interaction robot 10, for the next User utterance=“Yes. Then”, the interaction robot 10 outputs System utterance=“Uh-huh”. This system utterance is a system utterance generated by the scenario-based interaction execution module 201 to give a back-channel feedback for the utterance “Yes. Then” after which the conversation still continues.

Note that, from User utterance=“Yes”, the situation analysis unit 162 recognizes (confirms) that the other party with whom the user ate ramen together in Osaka yesterday is Mr. A. As a result, the situation analysis unit 162 can recognize the episode in more detail by combining the episode “I ate ramen in Osaka yesterday” based on the user utterance at this time and the episode “I ate ramen with Mr. A” recognized on the basis of the user utterance in the past. That is, the situation analysis unit 162 can recognize the episode that the user ate ramen in Osaka yesterday with Mr. A.

Next, as illustrated in A of FIG. 28, the situation analysis unit 162 recognizes that the user has got burned, on the basis of the next User utterance=“I got burned”. Furthermore, the situation analysis unit 162 recognizes that the burn injury causes pain, for example, on the basis of Impression knowledge stored in the RDF knowledge DB 213. The situation analysis unit 162 generates situation information indicating that the user has got burned and feels pain, and supplies the situation information to the processing determination unit 163.

In response to this, the interaction robot 10 outputs System utterance=“Oh no, are you ok?”. This system utterance is, for example, a system utterance generated by the scenario-based interaction execution module 201 on the basis of a situation in which the user has got burned and feels pain. That is, as illustrated in A of FIG. 28, the scenario-based interaction execution module 201 generates a question for finding out about an episode after the burning and painful situation, on the basis of question knowledge stored in the scenario DB 211.

Next, as illustrated in B of FIG. 28, the situation analysis unit 162 recognizes the result that the user has recovered from the burn injury on the basis of the next User utterance=“Recovered already”. The situation analysis unit 162 generates situation information indicating that the user has recovered from the burn injury, and supplies the situation information to the processing determination unit 163.

In response to this, the interaction robot 10 outputs System utterance=“Oh, good. Why did you get burned?”

System utterance=“Oh, good” is, for example, a system utterance generated by the scenario-based interaction execution module 201 on the basis of a situation where the burn injury of the user has been healed.

System utterance=“Why did you get burned?” is, for example, a system utterance generated by the episode knowledge-based interaction execution module 202. That is, as illustrated in B of FIG. 28, the episode knowledge-based interaction execution module 202 focuses on the burn injury instead of recovery from the burn injury, and generates a system utterance that inquires about the cause.

Next, as illustrated in C of FIG. 28, the situation analysis unit 162 recognizes a situation in which the user got burned because the soup was hot in combination with the previous user utterance, on the basis of the next User utterance=“The soup was hot”. Moreover, in combination with the previous user utterance, the situation analysis unit 162 recognizes a situation in which the user got burned because the soup was hot, but the burn injury has been healed. The situation analysis unit 162 generates situation information indicating that the user got burned because the soup was hot but the burn injury has been healed, and supplies the situation information to the processing determination unit 163.

In response to this, the interaction robot 10 outputs System utterance=“The soup was hot, so you got burned”. This system utterance is, for example, a system utterance generated by the scenario-based interaction execution module 201 on the basis of a situation in which the user got burned because the soup was hot. As a result, the user is notified that the interaction robot 10 has understood the cause of the burn of the user.

As described above, the system utterance is output so as to prompt a user utterance including information necessary for at least one of recognition of an episode or recognition of a relationship between a plurality of the episodes.

For example, the system utterance is output so as to prompt a user utterance including a cause and a result of a certain episode.

For example, although not included in the above-described example, the system utterance is output so as to prompt a user utterance including missing information in information including 5W1H in an episode that has been recognized. For example, the system utterance is output so as to prompt a user utterance including information such as a time and a place at which the episode occurred.

As a result, in an interaction between the user and the interaction robot 10, it is possible to expand an episode spoken by the user, and the information processing device 100 can increase knowledge regarding the user.

For example, the interaction robot 10 can interact while estimating details of the episode spoken by the user, on the basis of knowledge acquired from user utterances in the past.

For example, the following interaction sequence is executed between the user and the interaction robot 10.
User utterance=“I listened to music yesterday”
System utterance=“Did you listen to jazz?”
User utterance=“I listened to jazz”
System utterance=“That's good”

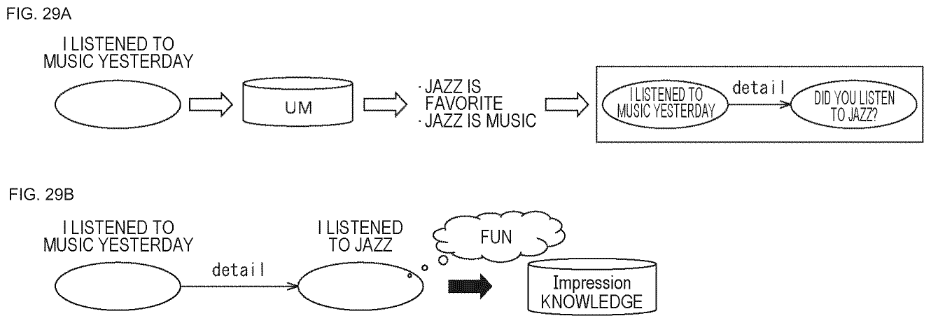

Here, with reference to FIG. 29, a process in which the interaction robot 10 outputs the system utterances in the above interaction sequence will be described.

FIG. 29 illustrates episode recognition process information similarly to FIGS. 27 and 28.

For example, as illustrated in A of FIG. 29, the situation analysis unit 162 generates situation information indicating that the user has said, “I listened to music yesterday” on the basis of the first User utterance=“I listened to music yesterday”, and supplies the situation information to the processing determination unit 163.

In response to this, the interaction robot 10 outputs System utterance=“Did you listen to jazz?”. This system utterance is, for example, a system utterance generated by the episode knowledge-based interaction execution module 202 on the basis of the episode that the user listened to music yesterday.

For example, as illustrated in A of FIG. 29, the episode knowledge-based interaction execution module 202 extracts information that the user likes jazz, on the basis of a user model (UM) stored in the user DB. The user model is a model representing features such as a user's preference. The information that the user likes jazz is, for example, knowledge acquired from user utterances in the past.

Furthermore, the episode knowledge-based interaction execution module 202 also collates the RDF knowledge DB 213 to extract information that jazz is music.

Then, the episode knowledge-based interaction execution module 202 estimates details of the episode that the user listened to music yesterday, and generates “Did you listen to jazz?” which is a system utterance for confirming the estimated content.

Next, as illustrated in B of FIG. 29, on the basis of the next User utterance=“I listened to jazz”, the situation analysis unit 162 recognizes an episode that the user listened to jazz, as details of the episode that the user listened to music yesterday. The situation analysis unit 162 generates situation information indicating an episode that the user listened to jazz yesterday, and supplies the situation information to the processing determination unit 163.

In response to this, the interaction robot 10 outputs System utterance=“That's good”. This system utterance is a system utterance generated by the scenario-based interaction execution module 201 on the basis of the episode that the user listened to jazz yesterday.

Specifically, the scenario-based interaction execution module 201 collates the RDF knowledge DB 213 and extracts information that it is fun to listen to favorite music. Then, the scenario-based interaction execution module 201 generates the system utterance “That's good” for the user having a pleasant experience of listening to favorite music.

As described above, details of the episode of the user are estimated on the basis of the user utterance at this time and the knowledge acquired from user utterances in the past, and the system utterance is output on the basis of a result of estimating the episode.

As a result, in an interaction between the user and the interaction robot 10, it is possible to expand an episode spoken by the user, and the information processing device 100 can increase knowledge regarding the user.

### [8. Configuration Example of Information Processing System of Present Disclosure]

Next, a configuration example of an information processing system of the present disclosure will be described.

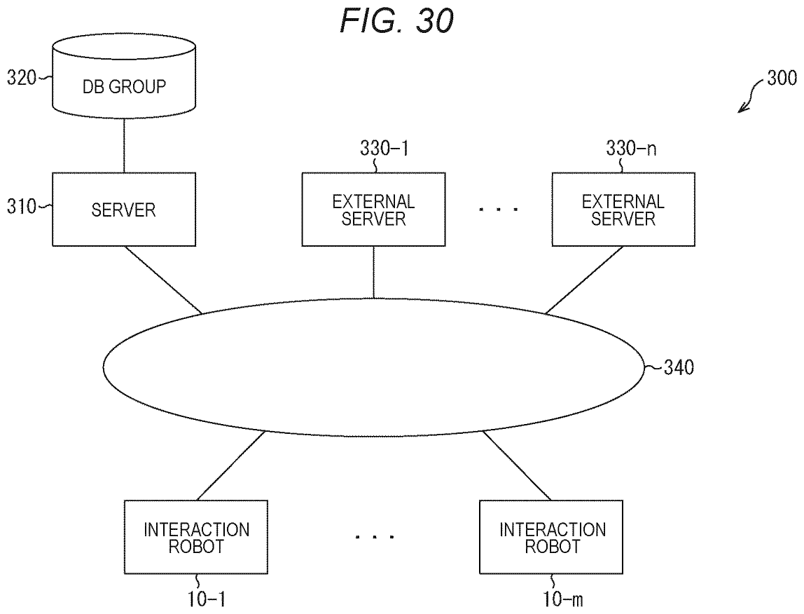

FIG. 30 illustrates a configuration example of an information processing system 300 of the present disclosure. Note that, in the figure, portions corresponding to those in FIG. 4 are denoted by the same reference numerals, and the description thereof will be omitted as appropriate.

The information processing system 300 includes an interaction robot 10-1 to an interaction robot 10-m, a server 310, a database (DB) group 320, and an external server 330-1 to an external server 330-n. The interaction robot 10-1 to the interaction robot 10-m, the server 310, the DB group 320, and the external server 330-1 to the external server 330-n are mutually connected via a network 340. The network 340 includes, for example, the Internet or the like.

Hereinafter, the interaction robot 10-1 to the interaction robot 10-m will be simply referred to as an interaction robot 10 in a case where it is not necessary to individually distinguish from one another. Hereinafter, the external server 330-1 to the external server 330-n will be simply referred to as the external server 330 in a case where it is not necessary to individually distinguish from one another.

Each interaction robot 10 includes the data input/output unit 110 in FIG. 4 and a communication unit (not illustrated). Each interaction robot 10 communicates with the server 310 via the network 340, and executes various types of processing such as an interaction with the user under the control of the server 310.

The server 310 includes the data processing unit 160 and the like in FIG. 4. The server 310 communicates with each interaction robot 10 and each external server 330 via the network 340. The server 310 controls each interaction robot 10 via the network 340. The server 310 collects various data to be used for controlling each interaction robot 10, from each interaction robot 10 and each external server 330 via the network 340. The server 310 analyzes the collected data, as necessary. The server 310 updates databases included in the DB group 320, on the basis of the collected data, an analysis result of the data, and the like.

The DB group 320 includes various databases to be used for processing of the server 310 and controlling each interaction robot 10.

The external server 330 is used, for example, for operating various services such as a web site. The external server 330 can be used to generate a system utterance of each interaction robot 10, for example, and holds various data not held by the DB group 320.

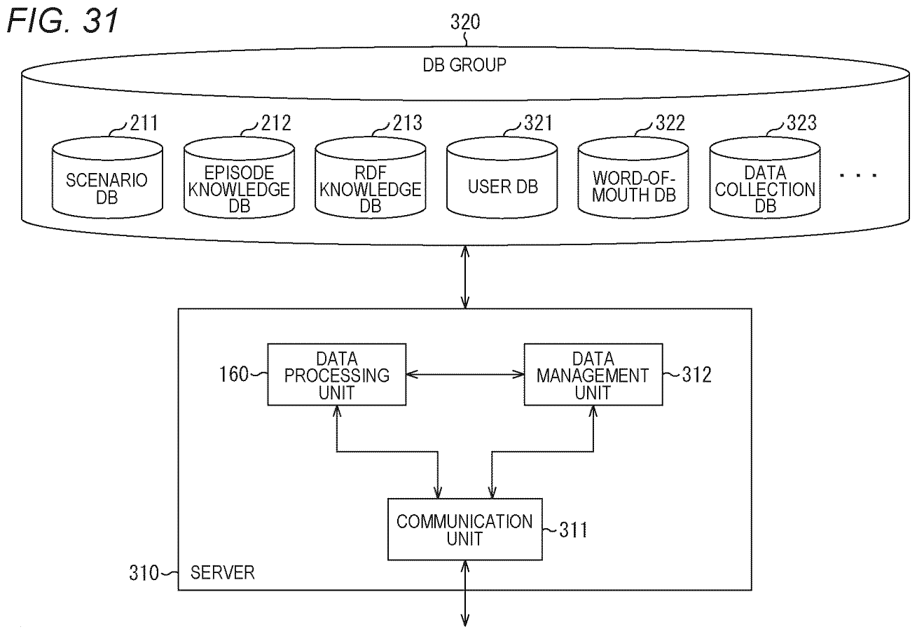

Next, a configuration example of the server 310 and the DB group 320 in FIG. 30 will be described with reference to FIG. 31. Note that, in the figure, portions corresponding to those in FIGS. 4, 9, 12, 15, and the like described above are denoted by the same reference numerals, and the description thereof will be omitted as appropriate.

The server 310 includes the data processing unit 160, a communication unit 311, and a data management unit 312.

The communication unit 311 communicates with each interaction robot 10 and each external server 330 via the network 340.

The data processing unit 160 controls each interaction robot 10 by communicating with each interaction robot 10 via the communication unit 311 and the network 340, and performing the above-described processing. For example, the data processing unit 160 analyzes a situation of each interaction robot 10, generates situation information, and supplies the situation information to the data management unit 312. For example, the data processing unit 160 generates a system utterance according to a situation of each interaction robot 10 and transmits the system utterance to each interaction robot 10 via the communication unit 311 and the network 340, thereby controlling the output of the system utterance of each interaction robot 10. For example, the data processing unit 160 generates drive control information according to a situation of each interaction robot 10 and transmits the drive control information to each interaction robot 10 via the communication unit 311 and the network 340, thereby driving each interaction robot 10.

The data management unit 312 manages data to be used for processing of the server 310 and controlling each interaction robot 10. The data to be used for controlling each interaction robot 10 includes, for example, data to be used for generating a system utterance of each interaction robot 10. For example, the data management unit 312 communicates with each interaction robot 10 and each external server 330 via the network 340. The data management unit 312 collects various data to be used for controlling each interaction robot 10, from each interaction robot 10 and each external server 330 via the network 340. The data management unit 312 analyzes collected data (including the situation information supplied from the data processing unit 160), as necessary. The data management unit 312 updates databases included in the DB group 320, on the basis of the collected data, an analysis result of the data, and the like.

The DB group 320 includes a user DB 321, a word-of-mouth DB 322, a data collection DB 323, and the like, in addition to the scenario DB 211, the episode knowledge DB 212, and the RDF knowledge DB 213 described above.

The user DB 321 stores various data related to the user of each interaction robot 10. For example, the user DB 321 stores the user model (UM) of each user described above, a habit episode, a common theme graph, and the like to be described later.

The word-of-mouth DB 322 stores, for example, word-of-mouth information of each user collected by the data management unit 312 from each interaction robot 10 and each external server 330.

The data collection DB 323 temporarily stores, for example, various unorganized data collected by the data management unit 312 from each interaction robot 10 and each external server 330.

Note that FIG. 31 illustrates only main elements necessary for explaining processing of the present disclosure. For example, the server 310 includes a control unit that controls execution processing, a storage unit that stores various data, a user operation unit, and the like, but configurations thereof are not illustrated.

Furthermore, hereinafter, in a case where the interaction robot 10, the server 310, and the external server 330 perform communication via the network 340, the description of “via the network 340” is omitted. For example, in a case where the interaction robot 10 and the server 310 communicate with each other via the network 340, it is simply described that the interaction robot 10 and the server 310 communicate with each other.

Moreover, hereinafter, in a case where each unit of the server 310 communicates with the interaction robot 10 or the external server 330 via the communication unit 311, the description of “via the communication unit 311” is omitted. For example, in a case where the data processing unit 160 communicates with the interaction robot 10 via the communication unit 311 and the network 340, it is simply described that the data processing unit 160 communicates with the interaction robot 10.

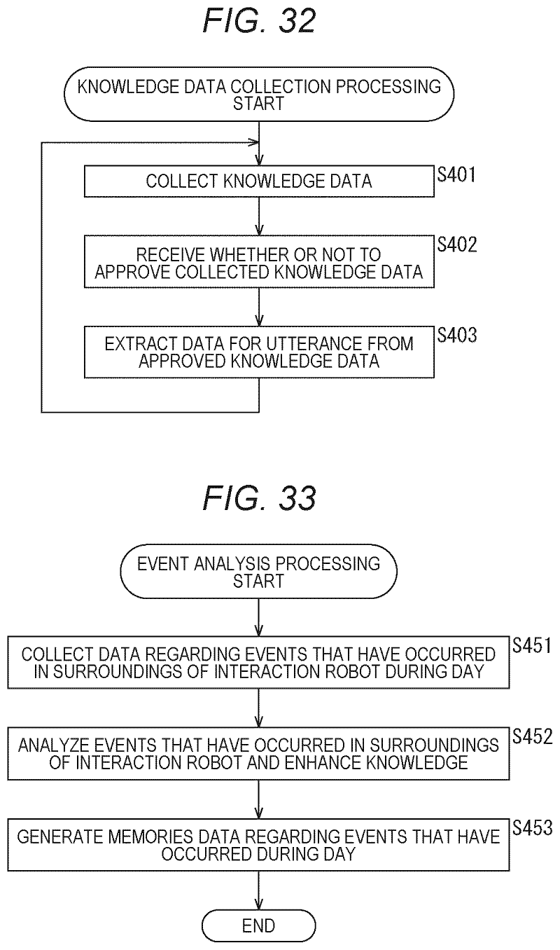

Next, with reference to FIGS. 32 to 36, processing of the information processing system 300 will be described.

### (Knowledge Data Collection Processing)

First, with reference to a flowchart of FIG. 32, knowledge data collection processing executed by the server 310 will be described.

This processing is started, for example, when power of the server 310 is turned on and is ended when power of the server 310 is turned off.

In step S401, the data management unit 312 collects knowledge data.

For example, the data management unit 312 discloses a website for knowledge data collection. This web site is, for example, a site for collecting knowledge regarding a plurality of themes from the user.

In response to this, for example, each user can post knowledge regarding a theme as a collection target on the website, by using a user terminal (for example, a personal computer (PC), a smartphone, or the like) not illustrated. Furthermore, each user can give evaluation to the posted knowledge of another user, by using the user terminal.

The data management unit 312 receives the knowledge data regarding the knowledge input by each user, via the network 340 and the communication unit 311. The data management unit 312 stores the received knowledge data in the data collection DB 323.

Note that the data management unit 312 collects knowledge data regarding each theme from the external server 330 as necessary, and stores the knowledge data in the data collection DB 323.

In step S402, the data management unit 312 receives whether or not to approve the collected knowledge data.

For example, a person in charge of operation of the server 310 determines whether or not to approve knowledge data newly accumulated in the data collection DB 323, on the basis of the viewpoint of AI ethics. Note that the AI ethics is, for example, a principle for preventing artificial intelligence (AI) from adversely affecting human beings.

The data management unit 312 leaves knowledge data approved by the person in charge of operation in the data collecting server 323 as it is, and deletes knowledge data not approved by the person in charge of operation from the data collecting server 323.

In step S403, the data management unit 312 extracts data for utterances, from the approved knowledge data.

For example, the data management unit 312 extracts knowledge data regarding knowledge estimated to be useful in an interaction by the interaction robot 10 with the user, from the knowledge data approved in the processing of step S402. Specifically, for example, the data management unit 312 extracts knowledge data in which an average value of evaluation by each user is a predetermined threshold value or more. For example, the data management unit 312 extracts knowledge data regarding a trend word that frequently appears in an interaction between each user and each interaction robot 10.

The data management unit 312 stores the extracted knowledge data in the DB group 320. For example, the data management unit 312 converts the extracted knowledge data into an episode format, and stores the converted knowledge data in the episode knowledge DB 212. For example, the data management unit 312 converts the extracted knowledge data into the RDF format, and stores the converted knowledge data in the RDF knowledge DB 213.

Thereafter, the processing returns to step S401, and the processing in and after step S401 is executed.

In this manner, the server 310 can easily collect knowledge data regarding useful knowledge that can be used for a system utterance of the interaction robot 10, from the knowledge that has been input by each user and is related to a predetermined theme. As a result, for example, a range of the interaction of the interaction robot 10 can be expanded.

Note that, for example, in a case where a word that the interaction robot 10 does not know (more precisely, a word whose information is not accumulated in the DB group 320) appears during an interaction with the user, the interaction robot 10 may collect information regarding the word and output a system utterance on the basis of a result of collecting information regarding an unknown word.

For example, the following interaction sequence is executed between the user and the interaction robot 10.
User utterance=“Do you know Niue?”
System utterance=“Yes, “Niue” is a nation having a territory of Niue island in the east of Ocean, and is a country with the second smallest population in the world”

For example, for the first User utterance=“Do you know Niue?”, the situation analysis unit 162 generates situation information indicating that the user has said “Do you know Niue?”, and supplies the situation information to the processing determination unit 163.

In response to this, the interaction robot 10 outputs System utterance=“Yes, “Niue” is a nation having a territory of Niue island in the east of Ocean, and is a country with the second smallest population in the world”.

In this system utterance, for example, the word “Niue” in the user utterance is an unknown word having no information stored in the DB group 320, and thus is a system utterance generated by the RDF knowledge-based interaction execution module 203 on the basis of a result of collecting information regarding “Niue” from the external server 330.

Note that, for example, in a case where the RDF knowledge-based interaction execution module 203 has not been able to collect information regarding “Niue” within a predetermined time, System utterance=“I don't know” is generated.

Furthermore, for example, the following interaction sequence is executed between the user and the interaction robot 10.
System utterance=“What country do you want to go to?”
User utterance=“Kiribati”
System utterance=“Kiribati? Good to know. Kiribati let me check”.
System utterance=“Kiribati is an atoll country located in the middle of the Pacific Ocean, where the sea is clear and one can enjoy diving, fishing, bird watching, and the like. I see”

For example, for the first System utterance=“What country do you want to go to?”, the user has answered “Kiribati”.

In response to this, the situation analysis unit 162 generates situation information indicating that the user has said “Kiribati” and supplies the situation information to the processing determination unit 163.

However, for example, since the information regarding “Kiribati” is not stored in the DB group 320, the interaction robot 10 outputs the following System utterance=“Kiribati?. Good to know. Kiribati . . . let me check”.

This system utterance is, for example, a system utterance generated by the RDF knowledge-based interaction execution module 203 to inform that it is necessary to check since the unknown word “Kiribati” appears and needs to be checked.

Then, for example, the RDF knowledge-based interaction execution module 203 accesses the external server 330 and collects information regarding “Kiribati”. Then, the interaction robot 10 outputs the nest System utterance=“Kiribati is an atoll country located in the middle of the Pacific Ocean, where the sea is clear and one can enjoy diving, fishing, bird watching, and the like. I see”

This system utterance is, for example, a system utterance generated by the RDF knowledge-based interaction execution module 203 on the basis of a result of collecting information regarding “Kiribati”.

As described above, the interaction robot 10 can continue the interaction with the user smoothly even if an unknown word (for example, a word whose information is not stored in the DB group 320) appears in the user utterance.

Note that the server 310 does not necessarily collect information regarding an unknown word every time the unknown word appears in the user utterance, and for example, may collect information, as necessary. For example, the server 310 may be configured to collect information regarding an unknown word in a case where the unknown word is included in a user utterance including an answer to a question included in a system utterance, in other words, in a case where the unknown word is included in the user's answer to the question of the interaction robot 10.

As a result, for example, in a case where the unknown word is not very important in the interaction with the user, the interaction robot 10 can continue the interaction smoothly without mentioning the word in detail. Whereas, in a case where the unknown word is important in the interaction with the user, the interaction robot 10 can appropriately react to the user utterance including the unknown word by collecting information regarding the word.

### (Event Analysis Processing)

Next, event analysis processing executed by the server 310 will be described with reference to a flowchart in FIG. 33.

Note that, although the event analysis processing for one interaction robot 10 will be described below, similar processing is executed for the other interaction robots 10.

In step S451, the server 310 collects data regarding events that have occurred in surroundings of the interaction robot 10 during the day.

For example, the situation analysis unit 162 of the data processing unit 160 of the server 310 generates situation information regarding situations of the interaction robot 10 and surroundings as described above, while the interaction robot 10 is in operation. Then, the situation analysis unit 162 appropriately supplies the generated situation information to the data management unit 312, and the data management unit 312 stores the acquired situation information in the data collection DB 323.

Furthermore, the image input unit 122 of the interaction robot 10 captures an image of surroundings of the interaction robot 10 (for example, a user or the like), and transmits the captured image to the server 310.

In response to this, the data management unit 312 of the server 310 receives the image from the interaction robot 10, and stores the image in the data collection DB 323.

As a result, data regarding events that have occurred in surroundings of the interaction robot 10 during the day is collected. The events that have occurred in surroundings of the interaction robot 10 include events that have occurred in the interaction robot 10 itself, such as an interaction with the user.

In step S452, the data management unit 312 analyzes events that have occurred in surroundings of the interaction robot 10 and enhances knowledge.

For example, at a predetermined time (for example, 23:00) every day, the data management unit 312 reads the situation information of the interaction robot 10 stored in the data collection DB 323 on that day, and analyzes events that have occurred in surroundings of the interaction robot 10.

The data management unit 312 extracts, for example, knowledge that can be used for a system utterance in knowledge about the user and surroundings of the interaction robot 10, on the basis of a result of analyzing events that have occurred in surroundings of the interaction robot 10. Furthermore, the data management unit 312 generates or updates various data stored in the DB group 320 on the basis of the extracted knowledge. For example, the data management unit 312 updates data regarding the user stored in the user DB 321 on the basis of the extracted knowledge.

Specifically, for example, the data management unit 312 updates a habit episode stored in the user DB 321. The habit episode is obtained by converting the user's habit into data by a histogram or the like, and includes, for example, data such as the number of times the user has performed a predetermined action this year (for example, the number of times of eating ramen).

For example, the data management unit 312 updates the user model stored in the user DB 321. For example, the data management unit 312 estimates a user's preference on the basis of the extracted knowledge, and adds information indicating the estimated user's preference (for example, what the user is likely to like) to the user model.

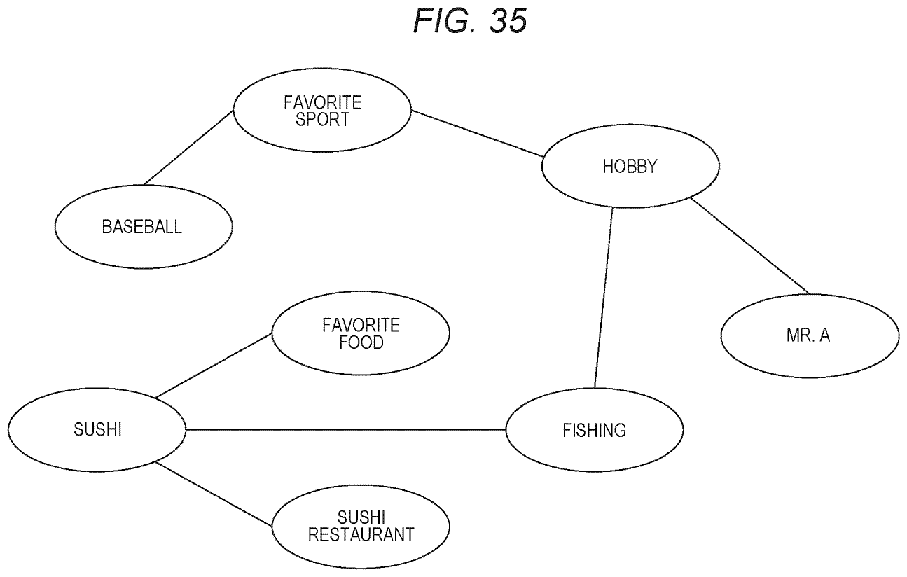

For example, the data management unit 312 updates a common theme graph stored in the user DB 321. Details of the common theme graph will be described later with reference to FIG. 35.

Note that, for example, the data processing unit 160 may improve accuracy of the acquired knowledge by performing control to output a system utterance for confirming the acquired knowledge in the interaction between the user and the interaction robot 10.

In step S453, the data management unit 312 generates memories data regarding events that have occurred during the day.

For example, the data management unit 312 documents events that have occurred in surroundings of the interaction robot 10 on the basis of a result of analyzing the events that have occurred in surroundings of the interaction robot 10, and generates text data regarding the events. Furthermore, the data management unit 312 extracts an image related to the documented event from the data collection DB 323, as necessary. The data management unit 312 generates memories data including the text data and the image related to the events. The memories data includes, for example, information regarding memories with the user.

The data management unit 312 stores the generated memories data in the episode knowledge DB 212. For example, the user can view the memories data by using the user terminal.

Thereafter, the event analysis processing ends.

As described above, the server 310 can acquire knowledge that can be used for a system utterance on the basis of events that have occurred in surroundings of the interaction robot 10.

Furthermore, by the server 310 generating and providing the memories data, the user's satisfaction with the interaction robot 10 can be increased.

### (Common Topic Recognition Processing)

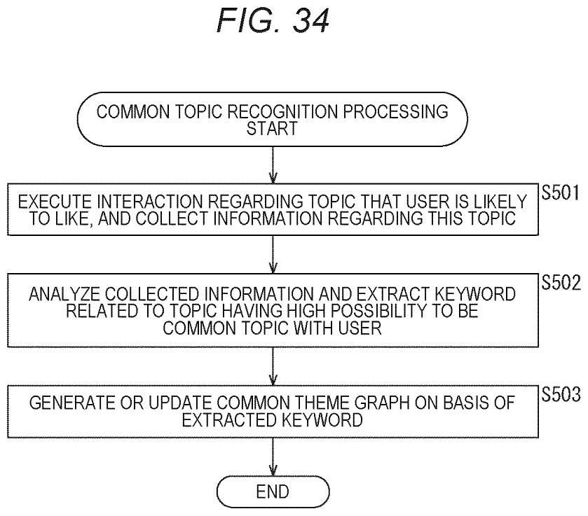

Next, common topic recognition processing executed by the server 310 will be described with reference to a flowchart of FIG. 34.

The common topic recognition processing is processing of recognizing (finding) a topic in common with the user, that is, a topic the user likes.

This processing is executed, for example, at a predetermined timing. For example, this processing is executed every day immediately after the user starts using the interaction robot 10, and thereafter, is executed at predetermined intervals.

In step S501, the server 310 executes an interaction regarding a topic that the user is likely to like, and collects information regarding the topic that the user is likely to like.

For example, in an interaction with the user, the data processing unit 160 intensively generates a system utterance regarding a topic that the user is likely to like and transmits the system utterance to the interaction robot 10, thereby causing the interaction robot 10 to output the system utterance regarding the topic that the user is likely to like.

Here, the topic that the user is likely to like is predicted on the basis of, for example, a questionnaire input in advance by the user, knowledge and an interaction history acquired by interactions with the user in the past, and the like. Note that, for example, immediately after the user starts using the interaction robot 10, the data processing unit 160 may randomly select a topic in order to guess a topic that the user is likely to like.

Furthermore, the state analysis unit 161 receives, from the interaction robot 10, acquired data regarding a system utterance, a reaction of the user, and the like in the interaction between the user and the interaction robot 10, and executes state analysis based on the acquired data. The state analysis unit 161 supplies state information indicating an analysis result to the situation analysis unit 162. The situation analysis unit 162 generates situation information by analyzing the state information, and supplies the situation information to the processing determination unit 163 and the data management unit 312.

The data management unit 312 stores the acquired situation information in the data collection DB 323.

The situation information includes, for example, information regarding contents of a user utterance, a reaction of the user to a system utterance, and the like.

In step S502, the server 310 analyzes the collected information and extracts a keyword related to a topic having a high possibility to be a common topic with the user.

For example, the data management unit 312 analyzes the situation information stored in the data collection DB 323 to estimate a topic (hereinafter, referred to as an estimated common topic) that is likely to be a common topic with the user. For example, a topic on which the user's reaction is good, a topic that frequently appears in user utterances, or the like is extracted as the estimated common topic.

Note that the number of estimated common topics to be extracted is not particularly limited.

Next, the data management unit 312 extracts a keyword whose frequency of appearance in user utterances is a predetermined threshold value or more in an interaction regarding the estimated common topic. As a result, a keyword indicating the preference of the user is extracted from the user utterance.

Note that the number of keywords to be extracted is not particularly limited.

Furthermore, the data management unit 312 detects a combination of keywords appearing for every interaction sequence, for the extracted keywords.

For example, in a case where Keywords A to C are extracted, processing is performed to detect, for example, a state in which only Keyword A appears in a user utterance in the first interaction sequence, and Keyword A and Keyword B appear in a user utterance in the second interaction sequence.

In step S503, the data management unit 312 generates or updates a common theme graph on the basis of the extracted keyword.

FIG. 35 illustrates an example of the common theme graph.

The common theme graph is a keyword (that is, a keyword indicating a preference of the user) having a high appearance frequency in user utterances in the estimated common topic, and keyword information indicating a relationship between keywords.

In the common theme graph, related keywords are connected by lines. For example, in this example, “favorite sport” and “baseball” are connected by a line and are related keywords.

Here, the related keywords are a combination of keywords having a high possibility of simultaneously appearing in the same interaction sequence. For example, “favorite sport” and “baseball” are a combination of keywords that are likely to simultaneously appear in the same interaction sequence. For example, “favorite food” and “baseball” are a combination of keywords that are less likely to simultaneously appear in the same interaction sequence.

Furthermore, a distance between the keywords is shorter as a relevance degree is higher, and the distance between the keywords is longer as the relevance degree is lower. For example, a distance between “sushi” and “sushi restaurant” is shorter than a distance between “sushi” and “fishing”. Therefore, in a case where the keyword “sushi” appears during an interaction with the user, there is a high possibility that the keyword “sushi restaurant” appears rather than “fishing” during the interaction.

The data management unit 312 stores the generated or updated common theme graph in the user DB 321.

Thereafter, the common topic recognition processing ends.

As described above, a topic that is likely to be a common topic with the user is estimated, and an important keyword regarding the estimated topic is extracted. Furthermore, a relationship between the extracted keywords is detected.

For example, in an interaction with the user, the data processing unit 160 generates and outputs a system utterance including a keyword included in the common theme graph, thereby enabling the interaction to be activated through the common topic with the user. Furthermore, for example, the data processing unit 160 can expand contents of the interaction by generating and outputting a system interaction including the related keyword.

As a result, it becomes possible to obtain more information from the user and quickly deepen understanding of the user.

Note that, by repeatedly executing the common topic recognition processing of FIG. 34 at an appropriate timing, it is possible to increase the number of keywords related to the common topic and to enhance accuracy of the keyword and the relationship between the keywords.

Furthermore, for example, the data management unit 312 may disclose or provide the common theme graph to the developer, the user, or the like of the interaction robot 10.

### (Word-of-Mouth Interaction Processing)

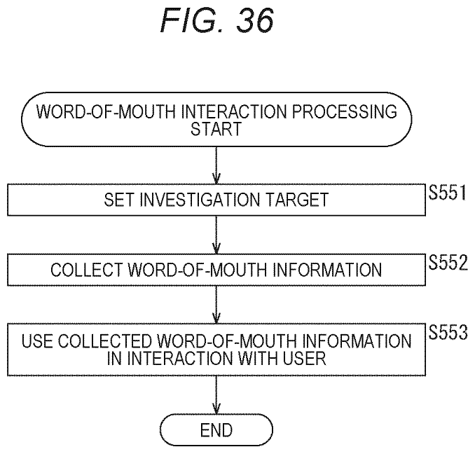

Next, word-of-mouth interaction processing executed by the server 310 will be described with reference to a flowchart of FIG. 36.

The word-of-mouth interaction processing is processing that uses word-of-mouth information collected from other users via other interaction robots 10, in an interaction between the user and the interaction robot 10.

In step S551, the data management unit 312 sets an investigation target.

For example, the data management unit 312 sets, as the investigation target, information regarding a topic that has appeared in an interaction between a user A and an interaction robot 10A.

For example, in a case where the following interaction between the user A and the interaction robot 10A is performed, “a restaurant where fried noodles are delicious” is set as the investigation target.
System utterance=“What is your favorite food?”
User utterance=“Fried noodles”
System utterance=“I see, fried noodles are delicious”

In step S552, the data management unit 312 collects word-of-mouth information.

For example, the data management unit 312 selects a user (hereinafter, referred to as an investigation target user) to be a target for collecting word-of-mouth information.

Note that a method of selecting the investigation target user is not particularly limited. For example, a user (for example, a user having a friendship with the user on a social networking service (SNS)) related to the user A is selected as the investigation target. Alternatively, for example, the investigation target user is randomly selected.

The data processing unit 160 controls the interaction robot 10 of each investigation target user to output a system utterance including a question regarding the set investigation target in an interaction with the investigation target user.

As a result, for example, during the interaction between each interaction robot 10 and each investigation target user, System utterance=“What is the restaurant where fried noodles are delicious?” is output.

Note that, at this time, each investigation target user may be notified that the acquired information will be disclosed to other users, by a system utterance.

Furthermore, the data processing unit 160 receives a user utterance including an answer to the system utterance from each interaction robot 10, and analyzes the user utterance. The data processing unit 160 supplies analysis information indicating a result of analyzing the user utterance of each investigation target user, to the data management unit 312.

The data management unit 312 acquires word-of-mouth information of each investigation target user regarding the investigation target, by further analyzing the analysis information of each investigation target user. The word-of-mouth information includes, for example, subjective information, evaluation, and the like on the investigation target of each investigation target user.

As a result, for example, word-of-mouth information regarding restaurants having delicious fried noodles is collected from each investigation target user.

The data management unit 312 stores the collected word-of-mouth information in the word-of-mouth DB 322.

In step S553, the server 310 uses the word-of-mouth information collected in an interaction with the user. For example, the data processing unit 160 generates a system utterance by using word-of-mouth information stored in the word-of-mouth DB 322, in an interaction with a user.

As a result, for example, the following utterance sequence is executed.
User utterance=“What should I eat today?”
System utterance=“Why don't you eat fried noodles? Speaking of fried noodles, there was a person who said, “Restaurant A in Chinatown is good”.”

Thereafter, the word-of-mouth interaction processing ends.

As described above, by using word-of-mouth information of another user, it is possible to widen a range of the interaction and provide useful information to the user.

Furthermore, since the timing of collecting and presenting word-of-mouth information is set on the basis of contents of interaction with the user, a natural user experience (UX) is realized.

### [9. Hardware Configuration Example of Information Processing Device]

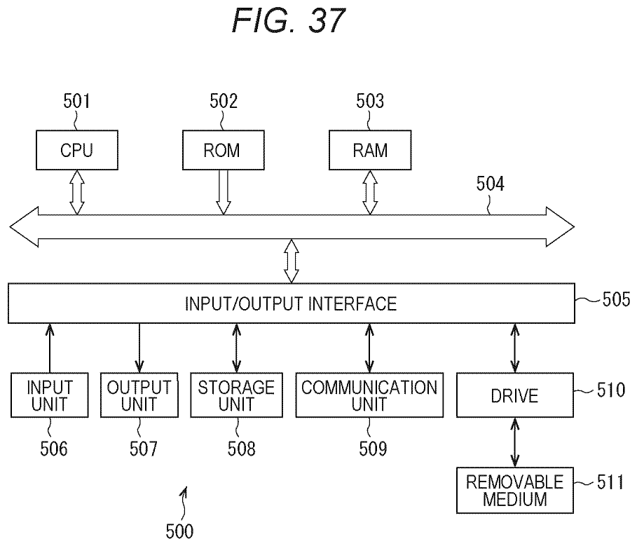

Next, a hardware configuration example of the information processing device will be described with reference to FIG. 37. The hardware described with reference to FIG. 37 is a hardware configuration example common to the information processing device 100 described with reference to FIG. 4, the server 310 described with reference to FIG. 31, and the like.

A central processing unit (CPU) 501 functions as a control unit or a data processing unit that executes various kinds of processing according to a program stored in a read only memory (ROM) 502 or a storage unit 508. For example, the CPU 501 executes the processing according to the sequence described in the above embodiment. A random access memory (RAM) 503 stores a program executed by the CPU 501, data, and the like. The CPU 501, the ROM 502, and the RAM 503 are mutually connected by a bus 504.

The CPU 501 is connected to an input/output interface 505 via the bus 504, and to the input/output interface 505, an input unit 506 that includes various switches, a keyboard, a mouse, a microphone, a sensor, or the like, and an output unit 507 that includes a display, a speaker, and the like are connected. The CPU 501 executes various kinds of processing in response to a command input from the input unit 506, and outputs a processing result to, for example, the output unit 507.

The storage unit 508 connected to the input/output interface 505 includes, for example, a hard disk, and the like and stores programs executed by the CPU 501 and various data. A communication unit 509 functions as a transmission-reception unit for Wi-Fi communication, Bluetooth (registered trademark) (BT) communication, and other data communication via a network such as the Internet or a local area network, and communicates with an external device.

A drive 510 connected to the input/output interface 505 drives a removable medium 511 such as a magnetic disk, an optical disc, a magneto-optical disk, or a semiconductor memory such as a memory card to record or read data.

### [10. Conclusion of Configuration of Present Disclosure]

As described above, the embodiment of the present disclosure has been described in detail with reference to the particular embodiment. However, it is obvious that those skilled in the art can modify or substitute the embodiment without departing from the gist of the present disclosure. That is, the present invention has been disclosed in the form of exemplification, and should not be interpreted in a limited manner. In order to determine the gist of the present disclosure, the claims should be considered.

Note that the technology disclosed herein may have the following configurations.

(1)

An information processing device including:
a data processing unit configured to execute at least one of recognition of an episode or recognition of a relationship between a plurality of the episodes, on the basis of a plurality of user utterances issued by a user.
   (2)

The information processing device according to (1) above, in which
the data processing unit controls output of a system utterance to the user.
   (3)

The information processing device according to (2) above, in which
the data processing unit controls output of the system utterance so as to prompt the user to issue, among the user utterances, a user utterance including information necessary for at least one of recognition of the episode or recognition of a relationship between a plurality of the episodes.
   (4)

The information processing device according to (3) above, in which
the data processing unit controls output of the system utterance so as to prompt the user to issue, among the user utterances, a user utterance including missing information in information including 5W1H in the episode that has been recognized.
   (5)

The information processing device according to any one of (2) to (4) above, in which
the data processing unit estimates a detail of the episode on the basis of a user utterance issued by the user at this time among the user utterances and knowledge acquired from a user utterance in past among the user utterances.
   (6)

The information processing device according to (5) above, in which
the data processing unit controls output of the system utterance on the basis of a result of estimating a detail of the episode.
   (7)

The information processing device according to any one of (2) to (6) above, further including:
a data management unit configured to manage data to be used for the system utterance.
   (8)

The information processing device according to (7) above, in which
the data management unit extracts knowledge to be used for the system utterance from knowledge regarding a predetermined theme, the knowledge being input by a plurality of users.
   (9)

The information processing device according to (7) or (8) above, in which
the data processing unit analyzes an event including an interaction with the user, and
the data management unit extracts knowledge to be used for the system utterance on the basis of a result of analyzing the event.
   (10)

The information processing device according to any one of (7) to (9) above, in which
in a case where an unknown word is included in each of the user utterances, the data management unit collects information regarding the unknown word, and
the data processing unit controls output of the system utterance on the basis of a result of collecting information regarding the unknown word.
   (11)

The information processing device according to (10) above, in which
in a case where the unknown word is included in, among the user utterances, a user utterance including an answer to a question included in the system utterance, the data management unit investigates information regarding the unknown word.
   (12)

The information processing device according to any one of (7) to (11) above, in which
the data management unit extracts a keyword indicating a preference of the user from each of the user utterances, and generates keyword information that is information indicating a relationship between the extracted keywords.
   (13)

The information processing device according to (12) above, in which
the data processing unit controls output of the system utterance to the user on the basis of the keyword information.
   (14)

The information processing device according to any one of (7) to (13) above, in which
the data management unit collects information regarding a predetermined investigation target from another user, and
the data processing unit controls output of the system utterance to the user on the basis of information collected from the another user.
   (15)

The information processing device according to (14) above, in which
the data management unit sets the investigation target on the basis of each of the user utterances.
   (16)

The information processing device according to any one of (2) to (15) above, in which
the data processing unit analyzes an event including an interaction with the user, and generates information regarding a memory with the user on the basis of a result of analyzing the event.
   (17)

The information processing device according to any one of (2) to (16) above, in which
the data processing unit controls output of the system utterance of an interaction robot.
   (18)

The information processing device according to any one of (1) to (17) above, in which
the data processing unit recognizes the episode in more detail on the basis of a user utterance issued by the user at this time among the user utterances and the episode recognized from a user utterance issued by the user in past among the user utterances.
   (19)

The information processing device according to any one of (1) to (18) above, in which
the data processing unit controls output of information indicating a process of executing at least one of recognition of the episode or recognition of a relationship between a plurality of the episodes, on the basis of a plurality of the user utterances.
   (20)

An information processing method including,
by an information processing device:
executing at least one of recognition of an episode or recognition of a relationship between a plurality of the episodes, on the basis of a plurality of user utterances issued by a user.

Furthermore, a series of processes described herein can be executed by hardware, software, or a configuration obtained by combining hardware and software. In a case of processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed in a computer from the recording medium, a program can be received via a network such as a local area network (LAN) or the Internet and installed in a recording medium such as an internal hard disk or the like.

Note that the various processes described herein may be executed not only in a chronological order in accordance with the description, but may also be executed in parallel or individually depending on processing capability of a device that executes the processing or depending on the necessity. Furthermore, a system herein described is a logical set configuration of a plurality of devices, and is not limited to a system in which devices of respective configurations are in the same housing.

### REFERENCE SIGNS LIST

10, 10-1 to 10 m Interaction robot
21 Server
22 Smartphone
23 PC
100 Information processing device
110 Data input/output unit
120 Input unit
121 Voice input unit
122 Image input unit
123 Sensors
130 Output unit
131 Voice output unit
132 Drive control unit
150 Robot control unit
160 Data processing unit
161 State analysis unit
162 Situation analysis unit
163 Processing determination unit
164 Interaction processing unit
165 Action processing unit
170 Communication unit
201 Scenario-based interaction execution module
202 Episode knowledge-based interaction execution module
203 RDF knowledge-based interaction execution module
204 Situation verbalization & RDF knowledge-based interaction execution module
205 Machine learning model-based interaction execution module
210 Execution processing determination unit
211 Scenario database
212 Episode knowledge database
213 RDF knowledge database
215 Machine learning model
300 Information processing system
310 Server
311 Communication unit
312 Data management unit
320 Database group
321 User database
322 Word-of-mouth database
323 Data collection database
330-1 to 330-n External server
501 CPU
502 ROM
503 RAM
504 Bus
505 Input/output interface
506 Input unit
507 Output unit
508 Storage unit
509 Communication unit
510 Drive
511 Removable medium

1. An information processing device comprising:
a data processing unit configured to execute at least one of recognition of an episode or recognition of a relationship between a plurality of the episodes, on a basis of a plurality of user utterances issued by a user.

2. The information processing device according to claim 1, wherein
the data processing unit controls output of a system utterance to the user.

3. The information processing device according to claim 2, wherein
the data processing unit controls output of the system utterance so as to prompt the user to issue, among the user utterances, a user utterance including information necessary for at least one of recognition of the episode or recognition of a relationship between a plurality of the episodes.

4. The information processing device according to claim 3, wherein
the data processing unit controls output of the system utterance so as to prompt the user to issue, among the user utterances, a user utterance including missing information in information including 5W1H in the episode that has been recognized.

5. The information processing device according to claim 2, wherein
the data processing unit estimates a detail of the episode on a basis of a user utterance issued by the user at this time among the user utterances and knowledge acquired from a user utterance in past among the user utterances.

6. The information processing device according to claim 5, wherein
the data processing unit controls output of the system utterance on a basis of a result of estimating a detail of the episode.

7. The information processing device according to claim 2, further comprising:
a data management unit configured to manage data to be used for the system utterance.

8. The information processing device according to claim 7, wherein
the data management unit extracts knowledge to be used for the system utterance from knowledge regarding a predetermined theme, the knowledge being input by a plurality of users.

9. The information processing device according to claim 7, wherein
the data processing unit analyzes an event including an interaction with the user, and
the data management unit extracts knowledge to be used for the system utterance on a basis of a result of analyzing the event.

10. The information processing device according to claim 7, wherein
in a case where an unknown word is included in each of the user utterances, the data management unit collects information regarding the unknown word, and
the data processing unit controls output of the system utterance on a basis of a result of collecting information regarding the unknown word.

11. The information processing device according to claim 10, wherein
in a case where the unknown word is included in, among the user utterances, a user utterance including an answer to a question included in the system utterance, the data management unit investigates information regarding the unknown word.

12. The information processing device according to claim 7, wherein
the data management unit extracts a keyword indicating a preference of the user from each of the user utterances, and generates keyword information that is information indicating a relationship between the extracted keywords.

13. The information processing device according to claim 12, wherein
the data processing unit controls output of the system utterance to the user on a basis of the keyword information.

14. The information processing device according to claim 7, wherein
the data management unit collects information regarding a predetermined investigation target from another user, and
the data processing unit controls output of the system utterance to the user on a basis of information collected from the another user.

15. The information processing device according to claim 14, wherein
the data management unit sets the investigation target on a basis of each of the user utterances.

16. The information processing device according to claim 2, wherein
the data processing unit analyzes an event including an interaction with the user, and generates information regarding a memory with the user on a basis of a result of analyzing the event.

17. The information processing device according to claim 2, wherein
the data processing unit controls output of the system utterance of an interaction robot.

18. The information processing device according to claim 1, wherein
the data processing unit recognizes the episode in more detail on a basis of a user utterance issued by the user at this time among the user utterances and the episode recognized from a user utterance issued by the user in past among the user utterances.

19. The information processing device according to claim 1, wherein
the data processing unit controls output of information indicating a process of executing at least one of recognition of the episode or recognition of a relationship between a plurality of the episodes, on a basis of a plurality of the user utterances.

20. An information processing method comprising,
by an information processing device:
executing at least one of recognition of an episode or recognition of a relationship between a plurality of the episodes, on a basis of a plurality of user utterances issued by a user.
